(19) United States
(12) Patent Application Publication
(10) Pub. No.: US 2011/0193865 A1
(43) Pub. Date: Aug. 11, 2011

(54) ELECTRONIC NOMOGRAM AND METHOD OF DISPLAYING ELECTRONIC NOMOGRAM

(76) Inventor: Shigeo NAKAISHI, Osaka (JP)

(21) Appl. No.: 13/086,800

(22) Filed: Apr. 14, 2011

Related U.S. Application Data
(63) Continuation of application No. PCT/JP2009/005270, filed on Oct. 9, 2009.

(30) Foreign Application Priority Data
Oct. 14, 2008 (JP) 2008-265417

(51) Int. Cl. G06T 11/20

(52) U.S. Cl. 345/440

(57) ABSTRACT

An electronic nomogram includes an image data storing unit for storing nomogram image data of a coordinate plane having a first axis and a second axis; an instruction receiving unit for receiving an instruction specifying a position of a point graphic displayed on a nomogram; a numerical value acquiring unit for acquiring first and second numerical values; a calculation unit for calculating a value of a calculation result of a predetermined function that uses as arguments the first and second numerical values; an image generation unit for generating point graphic image data at a position specified by the received instruction and generating as calculation result image data, image data of the value of the calculation result of the function; and an image display unit for displaying the nomogram image data, the point graphic image data and the calculation result image data.

### CROSS-REFERENCE TO RELATED APPLICATIONS

This is a continuation application of a prior PCT application No. PCT/JP2009/005270, filed on Oct. 9, 2009, pending, which claims priority of a prior Japanese Patent application No. 2008-265417, filed on Oct. 14, 2008.

### BACKGROUND OF THE INVENTION AND RELATED ART STATEMENT

The present invention relates to an electronic nomogram and the like for displaying on a nomogram a point graphic indicating a position.

### BACKGROUND ART

Nomograms printed on paper have been conventionally used. Nomograms displayed on a browser have also been provided on the web. For example, a web site operated by Health Canada presents a BMI (Body Mass Index) nomogram, in which a point graphic is displayed on the nomogram in response to the text input of the height and body weight of a person (see non-patent document 1, for example). Another web site presented discloses a nomogram of a growth curve of infants and babies in which coordinates corresponding to a point on the nomogram are simply displayed by vertical and horizontal straight lines intersecting at the position of a mouse pointer (see non-patent document 2, for example). Nomograms printed on books are also available (see non-patent document 3, for example).
Non-patent document 1: Body Mass Index (BMI) Nomogram, online, searched Oct. 10, 2008, Internet (URL: http://www.hc-sc.gc.ca/fn-an/nutrition/weights-poids/guide-ld-adult/bmi_chart_Java-graph_imc_Java-eng.php, and the like).
Non-patent document 2: “Hatuiku kyokusen (growth curve),” online, searched Oct. 10, 2008, Internet (URL: http://www15.big.or.jp/˜lion/seityo/infantmn.html and the like)
Non-patent document 3: “Tounyoubyou ryakugo jiten (dictionary of abbreviations in diabetes mellitus)” authored and edited by Takashi KADOWAKI, Nihon Rinsho-sha, March 2000

The problem is that conventional nomograms are not user-friendly. According to the Health Canada web site, the height and the body weight need to be input in text, and both a pointing device such as a mouse for operating the browser and a keyboard for entering numerical values are to be used. Complex input operations are needed. In particular, when an input value needs to be modified, new numerical values are input for modification. The input operation is not user friendly. For example, since the vertical line and the horizontal line intersect at the mouse pointer in the nomogram of the web site of non-patent document 2, only approximate values of the height, the body weight, and the percentile of the growth rate are known. It is difficult to input or calculate precise values. The related-art nomogram printed on paper cannot provide precise values but approximate values.

The invention is intended to overcome the above-described problem, and has the object to provide an electronic nomogram and the like, which is more user-friendly than the relate-art nomograms.

### SUMMARY OF THE INVENTION

To achieve the above object, an electric nomogram of the invention includes an image data storing unit for storing, as nomogram image data, image data of a nomogram with a coordinate plane having a first axis and a second axis, an instruction receiving unit for receiving an instruction specifying a position of a point graphic displayed on the nomogram and used to indicate a position on the nomogram, a numerical value acquiring unit for acquiring first and second numerical values, the first and second numerical values being respectively first and second axis values corresponding to the position of the point graphic on the nomogram, a calculation unit for calculating a value of a calculation result of a predetermined function that uses as arguments the first and second numerical values acquired by the numerical value acquiring unit, an image generation unit for generating, as point graphic image data, image data of the point graphic at a position specified by the instruction received by the instruction receiving unit and generating, as calculation result image data, image data of the value of the calculation result calculated by the calculation unit, and an image display unit for displaying the nomogram image data read from the image data storing unit, and the point graphic image data and the calculation result image data, generated by the image generation unit.

With this arrangement, the position of the point graphic displayed on the nomogram is specified not by text inputting but by a GUI (Graphical User Interface). For example, the position of the point graphic corresponding to the first and second axis values may be specified using only a pointing device. Since a pointing device such as a mouse is used to specify the position of the point graphic, the pointing device may be used for some other purpose once the position of the point graphic is specified. A value of a calculation result of a predetermined function corresponding to the position of the point graphic is easily obtained.

In the electronic nomogram of the invention, the image generation unit may also generate, as first numerical image data, image data of the first numerical value acquired by the numerical value acquiring unit and, as second numerical image data, image data of the second numerical value acquired by the numerical value acquiring unit, and the image display unit may also display the first numerical image data and the second numerical image data.

With this arrangement, the first and second axis values corresponding to the position of the point graphic are easily obtained.

The electronic nomogram of the invention may further include a function value receiving unit for receiving as a function value a value of the predetermined function and a graph generation unit for generating a graph in accordance with which the predetermined function provides the function value received by the function value receiving unit, and for modifying the nomogram image data such that the graph is displayed on the nomogram.

With this arrangement, the graph in accordance with which the predetermined function provides an expected function value is displayed on the nomograph.

In the electronic nomogram of the invention, the instruction receiving unit may receive an instruction specifying a position through which the graph of the predetermined function displayed on the nomogram runs. The numerical value acquiring unit may acquire the first and second axis values corresponding to the position specified by the instruction received by the instruction receiving unit. The calculation unit may calculate the value of the calculation result of the function of the predetermined function that uses as the arguments the first and second numerical values, corresponding to the position specified by the instruction received by the instruction receiving unit, and acquired by the numerical value acquiring unit. The function value receiving unit may receive as the function value the value of the calculation result corresponding to the position specified by the instruction received by the instruction receiving unit.

With this arrangement, the position of the graph to be displayed is specified using the GUI.

In the electronic nomogram of the invention, the nomogram image data may be partitioned into a plurality of regions in response to the value of the calculation result of the predetermined function. The electronic nomogram may further include a boundary value receiving unit for receiving a boundary value serving as a value corresponding to a boundary of the regions, and a boundary modifying unit for modifying the nomogram image data such that a graph in accordance with which the predetermined function provides the boundary value received by the boundary value receiving unit is the boundary of the regions.

With this arrangement, the boundary of the plurality of regions may be modified.

In the electronic nomogram of the invention, the instruction receiving unit may receive an instruction specifying a position through which the graph of the predetermined function corresponding to the boundary of the regions displayed on the nomogram runs. The numerical value acquiring unit may acquire the first and second axis values corresponding to the position specified by the instruction received by the instruction receiving unit. The calculation unit may calculate the value of the calculation result of the predetermined function that uses as the arguments the first and second numerical values, corresponding to the position specified by the instruction received by the instruction receiving unit, and acquired by the numerical value acquiring unit. The function value receiving unit may receive as the function value the value of the calculation result corresponding to the position specified by the instruction received by the instruction receiving unit.

With this arrangement, the position of the boundary of the regions may be modified using the GUI.

In the electronic nomogram of the invention, the nomogram image data may be partitioned into a plurality of regions in response to the value of the calculation result of the predetermined function, and at least one of the regions may serve as a target region. The electronic nomogram may further include a difference information generation unit for generating, as difference information, information related to a difference between the first axis values of the position of the point graphic and the target region and/or a difference between the second axis values of the position of the point graphic and the target region. The image generation unit may generate, as difference information image data, image data of the difference information generated by the difference information generation unit, and the image display unit may also display the difference information image data.

With this arrangement, the difference information may allow a user to easily learn what change causes the target region to be reached.

In the electronic nomogram of the invention, the instructing receiving unit may receive the instruction specifying positions of a plurality of point graphics. The image generation unit may generate image data of the plurality of point graphics, and the image display unit may display the image data of the plurality of point graphics.

With this arrangement, the plurality of point graphics are displayed for comparison.

In the electronic nomogram of the invention, the plurality of point graphics respectively correspond to different targets defined by the first and second axis values.

With this arrangement, the plurality of targets are compared with each other.

In the electronic nomogram of the invention, the plurality of point graphics may respectively correspond to a history of the same target defined by the first and second axis values.

With this arrangement, a plurality of pieces of past information are compared with each other.

An electronic nomogram of the invention includes an image data storing unit for storing, as nomogram image data, image data of a nomogram with a coordinate plane having a first axis and a second axis, an instruction receiving unit for receiving an instruction specifying a position of a point graphic displayed on the nomogram and used to indicate a position on the nomogram, a numerical value acquiring unit for acquiring first and second numerical values, the first and second numerical values being respectively first and second axis values corresponding to the position of the point graphic on the nomogram, a calculation unit for calculating a value of a calculation result of a predetermined function that uses as arguments the first and second numerical values acquired by the numerical value acquiring unit, an output unit for outputting the value of the calculation result of the function calculated by the calculation unit, an image generation unit for generating, as point graphic image data, image data of the point graphic at a position specified by the instruction received by the instruction receiving unit, and an image display unit for displaying the nomogram image data read from the image data storing unit, and the point graphic image data generated by the image generation unit.

With this arrangement, the value of the calculation result is output. For example, the values of the calculation results may be automatically accumulated in a database such as an electronic medical record.

In the electronic nomogram of the invention, the output unit may output the first and second numerical values acquired by the numerical value acquiring unit.

With this arrangement, the first and second numerical values are output together with the value of the calculation result. For example, the first and second numerical values may be accumulated together with the value of the calculation result on a database or the like.

### ADVANTAGES OF THE INVENTION

The electronic nomogram of the invention provides higher operational user-friendliness than the related-art electronic nomogram. For example, the use of the electronic nomogram allows a user to obtain a precise value of BMI.

### BRIEF DESCRIPTION OF THE DRAWINGS

FIG. 1 is a block diagram illustrating a configuration of an electronic nomogram of an embodiment 1 of the invention.

FIG. 2 is a flowchart illustrating an operation of the electronic nomogram of the embodiment.

FIG. 3 is a flowchart illustrating the operation of the electronic nomogram of the embodiment.

FIG. 4 illustrates an example of a display of the embodiment.

FIG. 5 illustrates an example of the display of the embodiment.

FIG. 6 illustrates an example of the display of the embodiment.

FIG. 7 illustrates an example of the display of the embodiment.

FIG. 8 illustrates an example of the display of the embodiment.

FIG. 9 illustrates an example of the display of the embodiment.

FIG. 10 illustrates an example of the display of the embodiment.

FIG. 11 illustrates an example of the display of the embodiment.

FIG. 12 illustrates an example of modification enabled/disabled information of the embodiment.

FIG. 13 illustrates an example of the display of the embodiment.

FIG. 14 illustrates an example of the display of the embodiment.

FIG. 15 is a block diagram illustrating another configuration of the electronic nomogram of the embodiment.

FIG. 16 is a diagrammatic view of the appearance of a computer system of the embodiment.

FIG. 17 is a view of a configuration of the computer system of the embodiment.

### DETAILED DESCRIPTION OF THE PREFERRED EMBODIMENTS

The embodiments of the electronic nomogram of the invention are described below. In the discussion that follows, elements or steps having the same reference numeral are identical to or correspond to each other, and the same discussion thereof may not be repeated.

### Embodiment 1

An electronic nomogram of embodiment 1 of the invention is described with reference to the drawings.

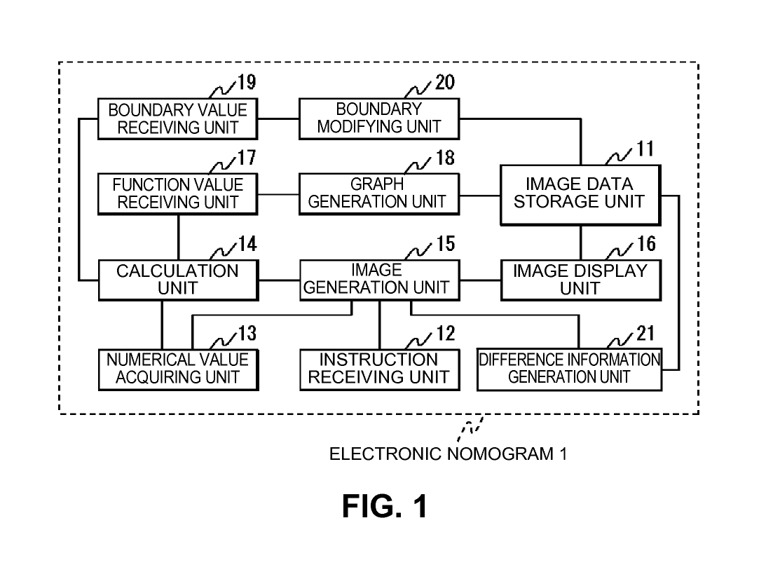

FIG. 1 is a block diagram illustrating a configuration of an electronic nomogram 1 of the embodiment. The electronic nomogram 1 of the embodiment includes image data storage unit 11, instruction receiving unit 12, numerical value acquiring unit 13, calculation unit 14, image generation unit 15, image display unit 16, function value receiving unit 17, graph generation unit 18, boundary value receiving unit 19, boundary modifying unit 20, and difference information generation unit 21. In the discussion of the embodiment, the apparatus having these elements is simply referred to as an “electronic nomogram.” The apparatus may also referred to as an electronic nomogram apparatus or an electronic nomogram display apparatus.

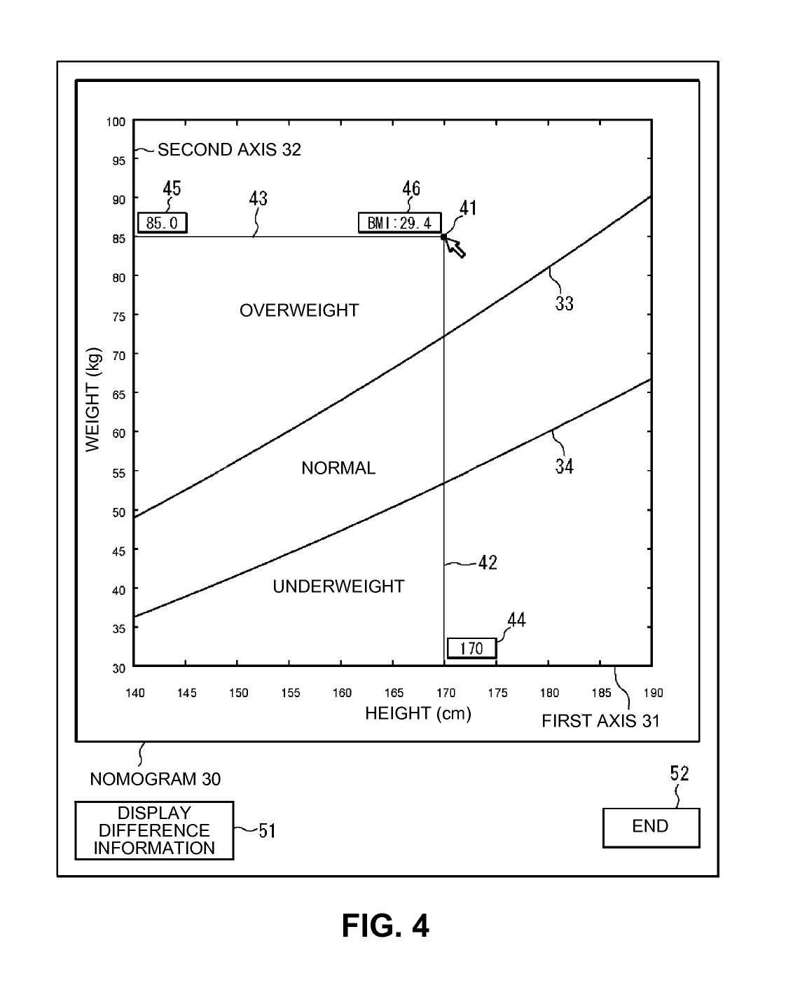

The image data storage unit 11 stores image data of a nomogram as nomogram image data. According to the embodiment, the nomogram is a coordinate plane having a first axis 31 and a second axis 32 as illustrated in FIG. 4, for example. The electronic nomogram 1 of the embodiment displays on a nomogram 30 a point graphic 41 to be discussed later. The values in first and second axes 31 and 32 corresponding to the position of the point graphic 41 are acquired. As illustrated in FIG. 4, the first and second axes 31 and 32 are straight lines on the coordinate plane, and the coordinate plane is a perpendicular coordinate plane with the first and second axes 31 and 32 being perpendicular to each other. The coordinate plane is not limited to the perpendicular coordinate plane. For example, the coordinate plane may be an oblique coordinate plane. Any nomogram image data is acceptable as long as the data can serve to display an image of a nomogram on a coordinate plane in any form. For example, the nomogram image data may be an image itself such as raster data. The nomogram image data may be vector data that can be rasterized into an image.

In the discussion of the embodiment, the nomogram is a nomogram for BMI calculation. The first axis 31 is thus an axis representing the height (cm) of a person as an argument. The second axis 32 is an axis representing the body weight (kg) of the person as an argument. The second axis 32 is perpendicular to the first axis 31. The horizontal axis represents height, and the vertical axis represents body weight in FIG. 4, but the setting may be reversed. Information indicating the argument represented by the first axis 31, for example, a character string “height,” may be displayed close to the axis as illustrated in FIG. 4. The first axis 31 may be marked with gradations and numerical values as illustrated in FIG. 4. The same is true of the second axis 32. Information indicating the argument represented by the second axis 32, for example, a character string “body weight,” may be displayed close to the axis as illustrated in FIG. 4. The second axis 32 may be marked with gradations and numerical values.

The nomogram displayed on the electronic nomogram 1 is not necessarily a nomogram for BMI calculation. For example, the nomogram may be HOMA-R nomogram (reference is made to Japanese Registered Utility Model No. 3144622), an eGFR nomogram, or another nomogram. The nomograms in the medical field are quoted here. The nomogram displayed on the electronic nomogram 1 may be applicable as a nomogram in a field other than the medical field.

The nomogram image data may be partitioned into a plurality of regions in response to a value of a calculation result of a predetermined function that uses as arguments the values in the first and second axes 31 and 32. The nomogram image data may not be partitioned. The partitioning of the nomogram image data into a plurality of regions in response to the value of the calculation result of the predetermined function means that the nomogram image data is partitioned into a plurality of regions in response to the range of the values of the calculation results of the predetermined function as illustrated in FIG. 4. The regions may be planar regions, linear regions, or dot-like regions. According to the embodiment, a first region boundary line 33 and a second region boundary line 34 partition the nomogram into three regions as illustrated in FIG. 4. The first boundary line 33 illustrates a parabolic curve that indicates the relationship of height and body weight with BMI being a first value. The second region boundary line 34 illustrates a parabolic curve that indicates the relationship of height and body weight with BMI being a second value. BMI is described by the following equation:

BMI=body weight (kg)/{height (m)}²

As seen from this equation, a curve with BMI being a constant value is a parabolic curve. According to the embodiment, the first value is “25,” and the second value is “18.5.” These values may be any other appropriate values.

In the nomogram 30 of FIG. 4 as the nomogram image data, the first and second region boundary lines 33 and 34 partition a coordinate plane into three regions and two boundary lines. More specifically, the coordinate plane is partitioned into a region delineated by the second axis 32, and the first region boundary line 33 (that region is referred to as a “first region”), a region delineated by the second axis 32, the first region boundary line 33, and the second region boundary line 34 (that region is referred to as a “second region”), a region delineated by the first axis 31, the second axis 32, and the second boundary line 34 (that region is referred to as a “third region”), and the first and second boundary lines 33 and 34. The first region boundary line 33 is a region boundary line along which BMI is 25, and the second region boundary line 34 is a region boundary line along which BMI is 18.5. The first region is a region where BMI is higher than 25. The second region is a region where BMI is higher than 18.5 but lower than 25. The third region is a region where BMI is lower than 18.5.

The first region having BMI higher than 25 is a region of “overweight.” The second region having BMI higher than 18.5 but lower than 25 is a region of “normal weight.” The third region having BMI lower than 18.5 is a region of “underweight.” As illustrated in FIG. 4, words “overweight,” “normal,” and “underweight” featuring the respective regions may be displayed on the respective regions.

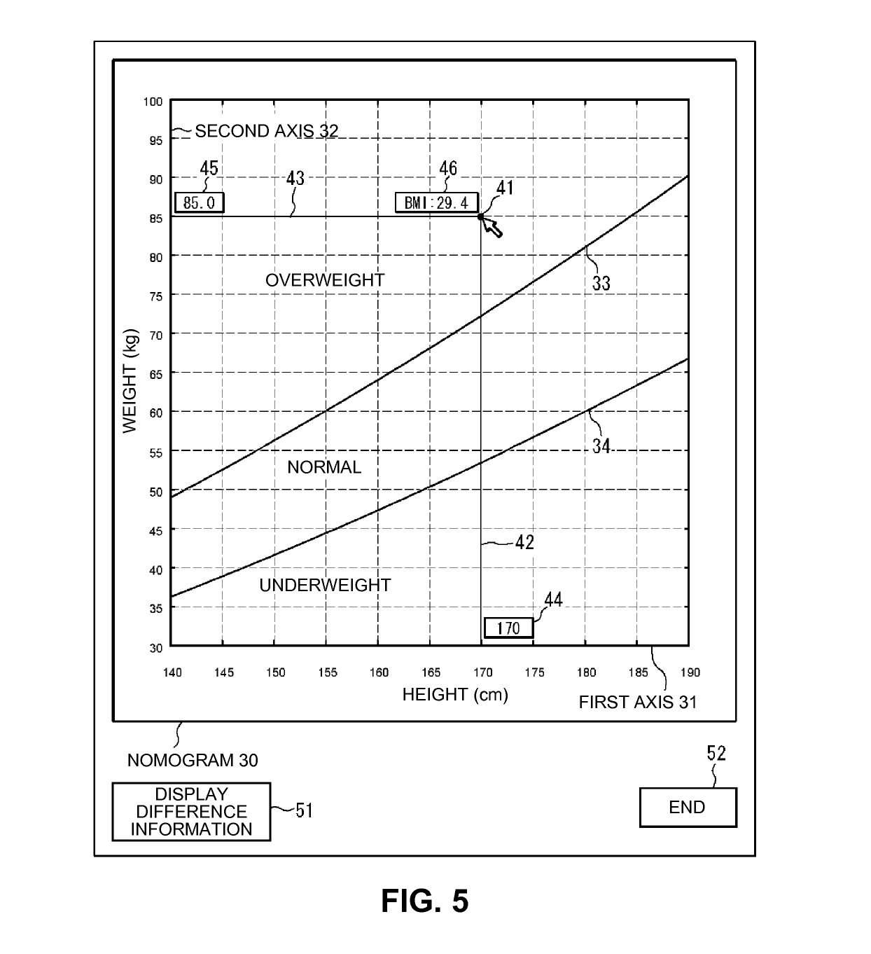

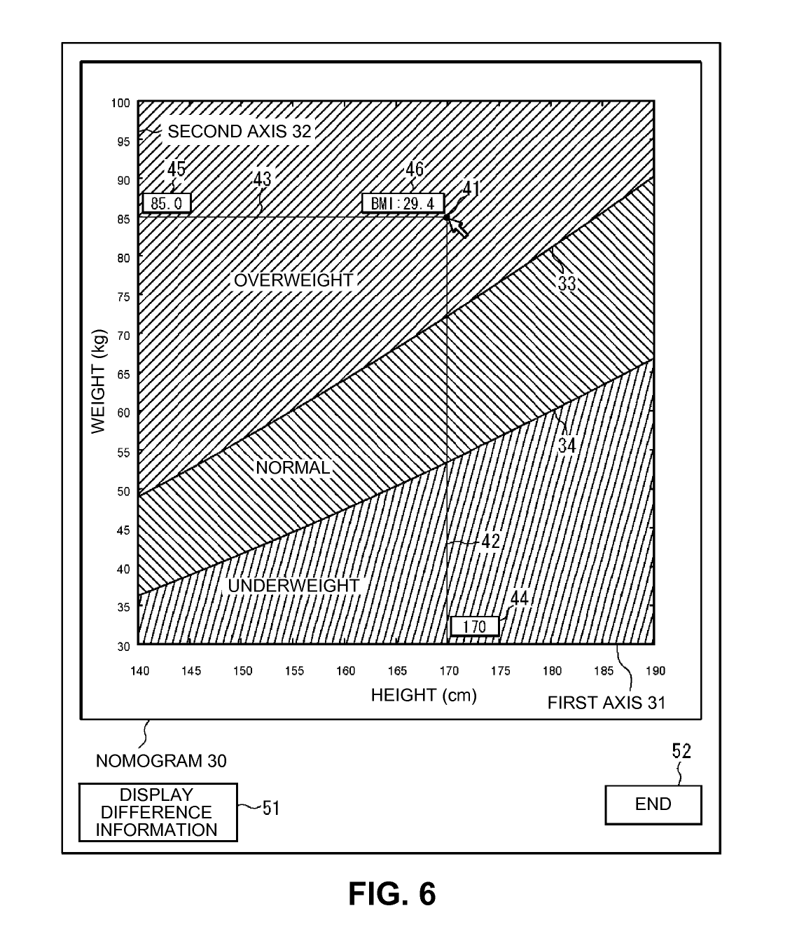

As illustrated in FIG. 5, gridlines parallel to the first axis 31 and the second axis 32 may be displayed in the nomogram 30. As illustrated in FIG. 6, different hatchings may be applied to the first through third regions in the nomogram 30 to allow a user to visibly easily discriminate the regions. Instead of difference hatchings, the regions may be differentiated with different colors. Another method may be used to allow a user to visibly easily discriminate the regions.

The process of storing the nomogram image data on the image data storage unit 11 is not limited to any process. For example, the nomogram image data may be stored on the image data storage unit 11 via a recording medium. The nomogram image data may be transmitted via a communication line or the like and then stored on the image data storage unit 11. The nomogram image data may be input via an input device and then stored on the image data storage unit 11. The storage of the nomogram image data on the image data storage unit 11 may be performed on a temporary basis, for example, on a RAM, or may be performed on a long-term basis. The image data storage unit 11 may be a predetermined recording medium (such as a semiconductor memory device, a magnetic disk, or an optical disk).

The instruction receiving unit 12 receives an instruction specifying a position of the point graphic 41. The point graphic 41 is a graphic displayed on the nomogram 30 and indicates a position on the nomogram 30. For example, the point graphic 41 is displayed at a position corresponding to the height and the body weight of a subject (user) on the nomogram 30 for BMI calculation of FIG. 4. The instruction receiving unit 12 may receive the instruction specifying the position of the point graphic 41 on the nomogram 30 via a mouse, a trackpad, a touchpanel, an arrow key, or the like. The instruction specifying the position of the point graphic 41 may be an instruction to determine the position of the point graphic 41 (such as clicking on the position of the point graphic 41). Alternatively, the instruction specifying the point graphic 41 may be an instruction to move the position of the point graphic 41 (such as dragging the point graphic 41 being displayed).

The instruction receiving unit 12 may receive an instruction specifying the position where a graph of the predetermined function runs on the nomogram 30. The instruction receiving unit 12 may also receive an instruction specifying the position where a graph of the predetermined function corresponding to the boundary of the region displayed on the nomogram 30 runs. If a plurality of point graphics 41 are displayed on the nomogram 30, the instruction receiving unit 12 may receive an instruction specifying the positions of the plurality of point graphics 41. The instruction receiving unit 12 may also receive an instruction to display difference information to be discussed later. The instruction receiving unit 12 preferably differentiates whether the received information is the instruction specifying the position of the point graphic 41, the instruction specifying the position of the graph of the function, the instruction specifying the position of the boundary, or the like. For example, a radio button or the like in the window of the nomogram 30 or in a different window may be used to select which input to be specified.

The instruction receiving unit 12 may receive information input on an input device (such as a keyboard, a mouse, or a touchpanel), for example. Alternatively, the instruction receiving unit 12 may receive information transmitted via a wired or wireless communication line. It is noted that the instruction receiving unit 12 may or may not include a device for reception (such as a modem or a network card). The instruction receiving unit 12 may be implemented based on hardware, or based on software such as a driver for driving a predetermined device.

The numerical value acquiring unit 13 acquires as a first numerical value a value in the first axis 31 and as a second numerical value a value in the second axis 32, corresponding to the position of the point graphic 41 on the nomogram 30. The value in the axis corresponding to the position of the point graphic 41 may be determined as below. In the case of the first axis 31, a line is drawn in parallel with the second axis 32 from the point graphic 41 and the value in the axis corresponding to the point graphic 41 is the value at the intersection of the line and the first axis 31. Similarly in the case of the second axis 32, a line is drawn in parallel with the first axis 31 from the point graphic 41 and the value in the axis corresponding to the point graphic 41 is the value at the intersection of the line and the second axis 32. The numerical value acquiring unit 13 may acquire the first and second numerical values, for example, by detecting the position of the point graphic 41 on a display screen and by converting the position into a position on the nomogram 30.

Alternatively, the numerical value acquiring unit 13 may acquire the values in the first and second axes 31 and 32 corresponding to a position specified by an instruction received by the instruction receiving unit 12 (a position unrelated to the point graphic 41). The acquisition of the values in the first and second axes 31 and 32 may be performed during the generation of the graph of the function to be discussed later or the modification of the boundary of the regions of the nomogram 30. The first and second numerical values acquired by the numerical value acquiring unit 13 may be stored on an unillustrated recording medium.

The calculation unit 14 calculates a value of a calculation result of the predetermined function with the first and second numerical values acquired by the numerical value acquiring unit 13 serving as arguments. In the embodiment, the predetermined function is an equation for BMI calculation. The predetermined function is stored on the unillustrated recording medium. The calculation unit 14 may read the predetermined function and then calculate the value of the calculation result of the predetermined function in response to the first and second numerical values. The value of the calculation result of the predetermined function calculated by the calculation unit 14 may be stored on the unillustrated recording medium.

The calculation unit 14 may calculate a value of a calculation result of the predetermined function with the values in the first and second axes 31 and 32 serving as arguments. The values in the first and second axes 31 and 32 acquired by the numerical value acquiring unit 13 correspond to the position specified by the instruction received by the instruction receiving unit 12.

The image generation unit 15 generates point graphic image data, first dropline graphic image data, second dropline graphic image data, first numerical image data, second numerical image data, calculation result image data, and difference information image data. These pieces of image data are described with reference to FIG. 4.

The point graphic image data is image data of the point graphic 41. The point graphic 41 is a graphic denoting a position on the nomogram 30 represented by the nomogram image data. The point graphic 41 is displayed on the nomogram 30. Whether the subject is overweight or not is determined by determining which region the point graphic 41 is located on. As illustrated in FIG. 4, the point graphic 41 may be a dot (or a circle), or may be another graphic such as a cross, a triangle, or a square.

If the instruction receiving unit 12 receives the instruction specifying the position of the point graphic 41, the image generation unit 15 generates the point graphic image data corresponding to the position specified by the instruction. More specifically, the image generation unit 15 may generate the point graphic image data such that the point graphic 41 is moved to the position specified by the instruction received by the instruction receiving unit 12. If the instruction receiving unit 12 receives the instruction specifying the position of the point graphic, the point graphic image data corresponding to the point graphic 41 displayed heretofore may be erased, and point graphic image data corresponding to a newly specified position may be generated. The generation of the point graphic image data corresponding to the specified position means that the point graphic image data for displaying the point graphic 41 at the specified position is generated.

The image generation unit 15 may generate a single piece of point graphic image data corresponding to the point graphic 41, or may generate a plurality of pieces of point graphic image data corresponding to a plurality of point graphics 41. The plurality of point graphics 41 may correspond to different targets defined by the values in the first and second axes 31 and 32. Alternatively, the plurality of point graphics 41 may correspond to a history of the same target defined by the values in the first and second axes 31 and 32. The “target” herein may be a subject or a thing having the measured values in the first and second axes 31 and 32, or may be another type of target.

The point graphic image data is the image data of the point graphic. The point graphic image data may be any type of image data as long as the data finally serves to display a point graphic. For example, the point graphic image data may be an image itself such as raster data, or may be vector data that can be rasterized into an image. The point graphic image data may be generated on the nomogram 30 represented by the nomogram image data, or may be generated separately from the nomogram 30. In the latter case, the point graphic image data preferably includes information representing a display position on the nomogram 30. The point graphic image data may be temporarily stored on the unillustrated recording medium or may be temporarily stored on the image data storage unit 11. The content described in this paragraph holds true of other graphic data generated by the image generation unit 15.

The first dropline graphic image data is image data of a first dropline graphic 32. The first dropline graphic 32 is a graphic of a dropline that is drawn from the point graphic 41 to the position in the first axis 31 corresponding to the point graphic 41 (line of fall). The value in the first axis 31 corresponding to the point graphic 41 is easily determined by the intersection of the first dropline graphic 32 and the first axis 31.

The second dropline graphic image data is image data of a second dropline graphic 33. The second dropline graphic 33 is a graphic of a dropline that is drawn from the point graphic 41 to the position in the second axis 32 corresponding to the point graphic 41. The value in the second axis 32 corresponding to the point graphic 41 is easily determined by the intersection of the second dropline graphic 33 and the second axis 32.

The first and second dropline graphics 42 and 43 are typically drawn in parallel with the first and second axes 31 and 32. The first and second dropline graphics 42 and 43 are not limited to those determined in this method as long as the values in the first and second axes 31 and 32 corresponding to the point graphic 41 are determined. The first and second dropline graphics 42 and 43 are typically a linear graphic.

The first numerical image data is image data of the first numerical value. The first numerical value is the value in the first axis 31 corresponding to the point graphic 41, acquired by the numerical value acquiring unit 13. With the first numerical value 44 displayed, the user can obtain the value in the first axis 31 corresponding to the point graphic 41. The first numerical value 44 may or may not be displayed in the vicinity of the position in the first axis 31 corresponding to the first numerical value. In the former case, a display position of the first numerical value 44 may be moved along with the movement of the point graphic 41. In the latter case, the first numerical value 44 may be always displayed at a predetermined position. The first numerical image data is image data typically representing a numerical value in text.

The second numerical image data is image data of the second numerical value. The second numerical value 45 is the value in the second axis 32 corresponding to the point graphic 41 acquired by the numerical value acquiring unit 13. With the second numerical value 45 displayed, the user can obtain the value in the second axis 32 corresponding to the point graphic 41. The second numerical value 45 is similar to the first numerical value 44 described above except that the two numerical values are different in value, and the detailed discussion thereof is omitted herein.

The calculation result image data is image data of the value of the calculation result of the predetermined function calculated by the calculation unit 14 to be discussed later. With the calculation result 46 displayed, the user can obtain the value of the calculation result of the function with the values in the first and second axes 31 and 32 corresponding to the point graphic 41 serving as arguments. More specifically, the user can obtain the value of BMI corresponding to the height and body weight input via the point graphic 41. The position where the calculation result 46 is displayed is not limited to any particular display position. As illustrated in FIG. 4, for example, the calculation result 46 may be displayed in the vicinity of the point graphic 41 or may be displayed at a predetermined position. The calculation result image data is typically the image data representing a numerical value in text.

The difference information image data is image data of difference information generated by the difference information generation unit 21 to be discussed later. With the difference information displayed, the user can obtain information related to the change in the value in the first axis 31 and/or the change in the value in the second axis 32 from the position of the point graphic 41 to a target region. For example, the user can know how much weight reduction is needed to reach a BMI region of target. If the difference information image data is generated, the nomogram image data is partitioned into a plurality of regions in response to the value of the calculation result of the predetermined function. At least one of the regions is a target region.

The image generation unit 15 may generate the point graphic image data and the like based on source image data pre-stored on the unillustrated recording medium. The source image data may be image data of a graphic used as a point graphic (such as a circular graphic), may be image data of a frame used when the first and second numerical image data and the calculation result image data are generated. The source image data may be other image data.

The image generation unit 15 may successively store the generated image data on the recording medium from which the image display unit 16 to be discussed later reads the image data. In such a case, the nomogram image data may also be stored on the recording medium, and the image display unit 16 may display the image data by simply reading and displaying the image data from the recording medium. The recording medium may be the image data storage unit 11.

The image display unit 16 displays a variety of pieces of image data including the nomogram image data read from the image data storage unit 11 and the point graphic image data generated by the image generation unit 15. The image display unit 16 is designed to provide a display output that is to be finally displayed as an image of the nomogram image data and the like. For example, the image display unit 16 may be a transmitter unit transmitting the image data and the like to a display device (such as a CRT or a liquid-crystal display). Alternatively, the image display unit 16 may or may not include a display device displaying the image data. The image display unit 16 may be implemented based on hardware, or based on software such as a driver for driving a predetermined display device.

The function value receiving unit 17 receives as a function value a value related to the predetermined function. The function value is used to generate a graph on the nomogram 30. The graph generation may be performed by generating a new graph or by shifting the existing graph in position. For example, the function value in the nomogram 30 for BMI calculation of FIG. 4 may be a BMI value. The function value may be input by receiving an input in text, or by specifying a point on the nomogram 30. The latter case is described here. Using a pointing device, the user may now specify on the nomogram 30 a position through which the graph of the predetermined function runs. The specifying of the position is performed when the user clicks on the position or drags the existing graph using the mouse or the like. The specified position is the position which the user has clicked on using the mouse, or the position where the user has set a button to an off position on the mouse after dragging the graph. The specified position is received by the instruction receiving unit 12. The numerical value acquiring unit 13 acquires the values in the first and second axes 31 and 32 corresponding to the specified position. The calculation unit 14 calculates the value of the calculation result of the predetermined function with the acquired values in the first and second axes 31 and 32 serving as the arguments. The value of the calculation result is the value of the predetermined function (a BMI value, for example), and is received by the function value receiving unit 17. The function value receiving unit 17 has thus received as the function value the value of the calculation result corresponding to the position specified by the instruction received by the instruction receiving unit 12. In a manner similar to the textual input method of the function value, the function value may be input using GUI. In the discussion of the embodiment, the function value is input through the GUI.

The function value receiving unit 17 may receive the function value input on the input device (such as the keyboard, the mouse, or the touchpad), the function value transmitted via a wired or wireless communication line, the function value read from a predetermined recording medium (such as an optical disk, a magnetic disk, or a semiconductor memory), or the function value from another element. The function value receiving unit 17 may or may not include a device for reception (such as a modem or a network card). The function value receiving unit 17 may be implemented based on hardware, or based on software such as a driver for driving a predetermined device.

The graph generation unit 18 generates a graph according to which the predetermined function provides the function value received by the function value receiving unit 17, and modifies the nomogram image data such that the graph is displayed on the nomogram. In the case of the nomogram for BMI calculation, the graph is generated according to which BMI is the function value, and added to the nomogram image data. The graph is typically one-dimensional linear. The graph may be a two-dimensional planar graph, or zero-dimensional dot-like graph. If the existing graph is moved, the graph generation unit 18 may erase the existing graph and modify the nomogram image data such that a new graph is displayed. The graph generation unit 18 may generate a single graph or may generate a plurality of graphs.

The boundary value receiving unit 19 receives as a boundary value a value corresponding to a boundary between regions. The boundary value is a value corresponding to a boundary of the regions if the nomogram is partitioned into a plurality of regions in response to the value of the calculation result of the predetermined function. In the nomogram 30 for BMI calculation as illustrated in FIG. 4, the first and second region boundary lines 33 and 34 partition the coordinate plane into the three regions. If the first region boundary line 33 is modified, a value of the predetermined function responsive to a modified first region boundary line 33 (the value of BMI here) is a boundary value to be received by the boundary value receiving unit 19. As the function value, the boundary value may also be input by receiving an input in text or by specifying a point on the nomogram 30. The latter case is identical to the inputting of the function value, and the discussion thereof is omitted herein. The boundary value is typically received in order to modify the existing boundary line to a new boundary line. Information identifying the boundary line serving as a modification target is preferably received together with the boundary value by the boundary value receiving unit 19. The information identifying the existing boundary line may be the value of the predetermined function corresponding to the boundary line (for example, a BMI value). In the embodiment, the boundary value is input through the GUI. If a new boundary is set up with the nomogram not partitioned into a plurality of regions, it may not be necessary to receive the information identifying the boundary line.

The boundary value receiving unit 19 may receive a boundary value input on the input device (such as the keyboard, the mouse, or the touchpad), a boundary value transmitted via a wired or wireless communication line, a boundary value read from a predetermined recording medium (such as an optical disk, a magnetic disk, or a semiconductor memory), or a boundary value from another element. The boundary value receiving unit 19 may or may not include a device for reception (such as a modem or a network card). The boundary value receiving unit 19 may be implemented based on hardware, or based on software such as a driver for driving a predetermined device.

The boundary modifying unit 20 modifies the nomogram image data such that the graph, according to which the predetermined function provides the boundary value received by the boundary value receiving unit 19, is the boundary of the regions. The description of the generation of the graph corresponding to the received boundary value is identical to the description of the graph generation unit 18. If the existing graph is moved, the boundary modifying unit 20 may modify the nomogram image data such that the existing boundary is erased, and such that a new boundary is displayed.

The difference information generation unit 21 generates, as the difference information, information related to a difference between the first axis values of the position of the point graphic 41 and the target region and/or a difference between the second axis values of the position of the point graphic 41 and the target region. The difference information may be the range value in the first axis 31 to go to the target region from the position of the point graphic 41, or the range value in the second axis 32 to go to the target from the position of the point graphic 41, or both. The difference information may be information related to the range value in the first axis 31 to go to the target region from the position of the point graphic 41, or information related to the range value in the second axis 32 to go to the target from the position of the point graphic 41, or information related to the range values in both the first axis 31 and the second axis 32 to go to the target from the position of the point graphic 41. In the case of the nomogram for BMI calculation, the difference information may be the value of the height, the value of the body weight, or both to go to the target region from the position of the point graphic 41, or an amount of exercise and an amount of consumed calories responsive to the value of the body weight. As for an argument, such as the height, typically not changing in a short-term period, information related to a change in the argument may not included in the difference information. With this arrangement, meaningless information (such as increasing or decreasing the height by 10 centimeters) may be prevented from being included in the difference information. A plurality of paths may be available to go to the target region from the position of the point graphic 41. For example, the value changes along the first axis 31 only in one path, the value changes along the second axis 32 only in another path, and the value changes along both the first and second axes 31 and 32 in yet another path.

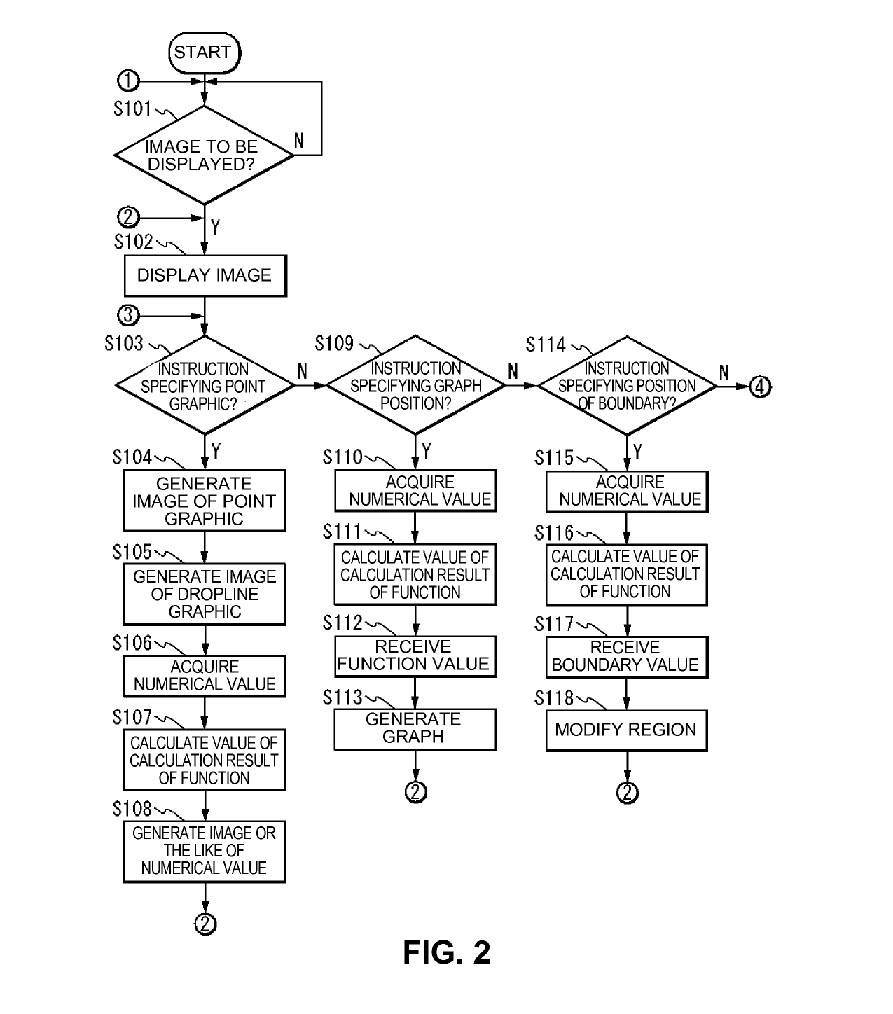

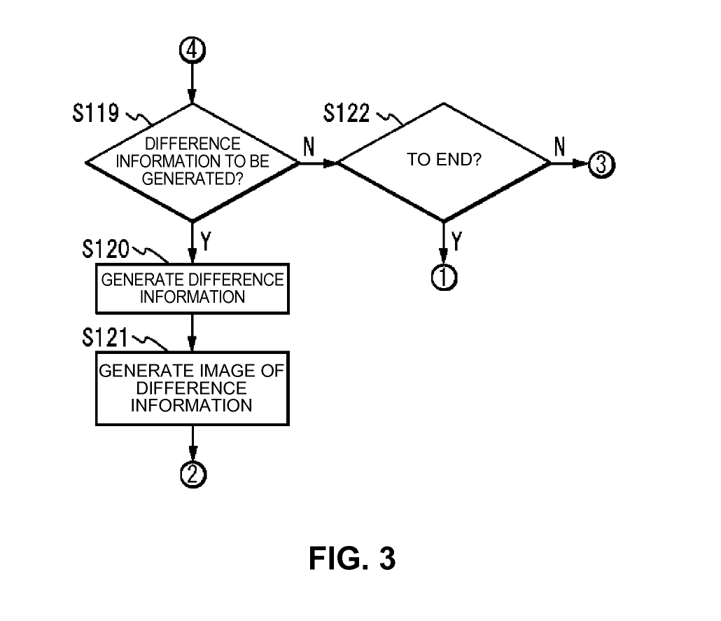

Operation of the electronic nomogram 1 of the embodiment is described with reference to flowcharts of FIGS. 2 and 3.

Step S101 The image display unit 16 determines whether to display the nomogram image data and the like. If the nomogram image data and the like are to be displayed, processing proceeds to step S102. If the nomogram image data and the like are not to be displayed, the operation in step S101 is repeated until it is determined that the nomogram image data and the like are to be displayed. The image display unit 16 may determine that the nomogram image data and the like are to be displayed if an instruction to display the nomogram image data and the like has been received. At a different timing, the image display unit 16 may determine that the nomogram image data and the like are to be displayed.

Step S102 The image display unit 16 displays the nomogram image data read from the image data storage unit 11 and the image data generated by the image generation unit 15. If the nomogram image data and the like are displayed for the first time, the image display unit 16 may or may not display the point graphic 41 at a predetermined position, and the first and second dropline graphics 42 and 43, the first and second numerical values 44 and 45, the calculation result 46, and the like corresponding to the position of the point graphic 41.

Step S103 The instruction receiving unit 12 determines whether the instruction specifying the position of the point graphic 41 has been received. If the instruction has been received, processing proceeds to step S104. If the instruction has not been received, processing proceeds to S109.

Step S104 The image generation unit 15 generates the point graphic image data in response to the instruction specifying the position of the point graphic 41 and received by the instruction receiving unit 12. For example, if the received instruction is an instruction to move the point graphic 41, the image generation unit 15 deletes the point graphic image data at this point of time, and generates point graphic image data at a destination. For example, if the received instruction is an instruction to newly display the point graphic 41, the image generation unit 15 generates point graphic image data at a specified position. The point graphic image data may be generated based on the point graphic 41 pre-stored on the unillustrated recording medium. For example, the generation of the point graphic image data may be include determining a display position of the point graphic 41.

Step S105 The image generation unit 15 generates, as the first and second dropline graphic image data, the image data of the first and second dropline graphics 42 and 43 respectively extending to the first and second axes 31 and 32 from the point graphic 41. For example, the X-axis coordinate value corresponding to the point graphic 41 on the screen coordinates is A, and the Y-axis coordinate value corresponding to the point graphic 41 on the screen coordinates is B, the first axis 31 is on a line having C in the Y axis of the screen coordinates, and the second axis 32 is on a line having D in the X axis of the screen coordinates. The image generation unit 15 may generate the first dropline graphic image data for displaying the first dropline graphic 42 as a line segment from (A,B) to (A,C). Similarly, the image generation unit 15 may generate the second dropline graphic image data for displaying the second dropline graphic 43 as a line segment from (A,B) to (D,B). Client coordinates may be used instead of the screen coordinates. The screen coordinates and the client coordinates are described below.

Step S106 The numerical value acquiring unit 13 acquires the first and second numerical values corresponding to the position of the point graphic 41. For example, the numerical value acquiring unit 13 acquires coordinate values corresponding to the position of the point graphic 41 in the screen coordinates. The coordinate values may be acquired by an operating system (OS). The screen coordinates refer to a coordinate system in which the top left corner of the display screen displaying the nomogram 30 or the like serves as the origin, from which the X axis extends rightward, and from which the Y axis extends downward. The client coordinates may be set, for example. In the client coordinates, the top left corner of the coordinate system of FIG. 4, i.e., the point (height, body weight)=(140,100) serves as the origin, from which the X axis extends rightward, and from which the Y axis extends downward. The client coordinates cover a rectangular area having points (height, body weight)=(140,100), (140,30), (190,30), and (190,100) serving as corners. The bottom left corner of the area of the client coordinates is set at (height, body weight)=(140,30), and the top right corner of the area of the client coordinates is set at (height, body weight)=(190,100). The numerical value acquiring unit 13 then converts the acquired coordinate values of the screen coordinates into the coordinate values of the client coordinates. Finally, the numerical value acquiring unit 13 acquires the first numerical value (the value of the height), and the second numerical value (the value of the body weight) by converting the client coordinates into the coordinate values of (height, body weight). The conversion of the coordinate value of the screen coordinates into the coordinate value of the client coordinates is known, and the detailed discussion thereof is omitted here. The conversion of the coordinate value of the client coordinates into the coordinate value of the first and second axes 31 and 32 is performed using a simple coordinates conversion technique.

For example, the coordinate system of (height, body weight) is set up as illustrated in FIG. 4. Let A represent a maximum value in the X axis of the client coordinates, and B represent a maximum value in the Y axis of the client coordinates. If the coordinate values of the client coordinates are (X,Y), (height, body weight) is represented by the following equation:

(height,body weight)=(140+50×X/A,100−70×Y/B)

Step S107 The calculation unit 14 calculates the value of the calculation result of the predetermined function based on the first and second numerical image data acquired by the numerical value acquiring unit 13.

Step S108 The image generation unit 15 generates the first and second numerical image data and the calculation result image data. Processing returns to step S102.

The generation process of the image generation unit 15 for generating the first and second numerical image data is described below. The image generation unit 15 generates the first numerical image data and the second numerical image data based on the first and second numerical values acquired by the numerical value acquiring unit 13. The image generation unit 15 may generate the first and second numerical image data by reading, as source image data, image data of a graphic such as a frame pre-stored on the unillustrated recording medium, and by setting the first and second numerical values in text in the image data. The display position of the first and second numerical values 44 and 45 may be set to be close to the first value in the first axis 31 and the second value in the second axis 32, respectively. In such a case, the image generation unit 15 may determine the display position of the first and second numerical values 44 and 45 by converting the coordinate system of the first and second axes 31 and 32 into the client coordinates.

The generation process of the image generation unit 15 for generating the calculation result image data is described below. The image generation unit 15 generates the calculation result image data based on the value of the calculation result of the predetermined function provided by the calculation unit 14. The image generation unit 15 may generate the calculation result image data by reading, as source image data, image data of a graphic such as a frame pre-stored on the unillustrated recording medium, and by setting the value of the calculation result of the predetermined function in text in the image data. The display position of the calculation result 46 may set to be close to the point graphic 41.

Step S109 The instruction receiving unit 12 determines whether the instruction specifying the position of the graph has been received. If the instruction specifying the position of the graph has been received, processing proceeds to step S110. If the instruction specifying the position of the graph has not been received, processing proceeds to S114.

Step S110 The numerical value acquiring unit 13 acquires the values in the first and second axes 31 and 32 corresponding to the position specified by the received instruction. This operation is performed in the same manner as in step S106.

Step S111 The calculation unit 14 calculates the value of the calculation result of the predetermined function based on the values in the first and second axes 31 and 32 acquired by the numerical value acquiring unit 13.

Step S112 The function value receiving unit 17 receives as the function value the value of the calculation result of the predetermined function provided by the calculation unit 14.

Step S113 The graph generation unit 18 generates the graph according to which the predetermined function provides the function value, and modifies the nomogram image data such that the graph is displayed on the nomogram. In the graph generation, the graph is preferably generated in accordance with the ranges of the values in the first and second axes 31 and 32 of the nomogram image data. For example, in the nomogram 30 of FIG. 4, the value in the first axis 31 may range from 140 to 190, and the value in the second axis 32 may range from 30 to 100. The graph generation unit 18 then generate the graph in those ranges. The position where the generated graph is added may be known by converting the value in the coordinate system of the first and second axes 31 and 32 into a coordinate value in the client coordinates. If the instruction received by the instruction receiving unit 12 is an instruction to move the graph, the graph generation unit 18 generates a graph after movement, and erases the graph as a movement target (i.e., the graph before movement). In the erasing of the graph, the graph generation unit 18 may convert the coordinate value of the graph before movement in the screen coordinates received by the instruction receiving unit 12 into a coordinate value in the client coordinates in order to identify the graph to be erased and then erases the identified graph. Processing returns to step S102.

Step S114 The instruction receiving unit 12 determines whether an instruction specifying a boundary of one of the regions has been received. If an instruction specifying a boundary has been received, processing proceeds to S115. If an instruction specifying a boundary has not been received, processing proceeds to S119.

Step S115 The numerical value acquiring unit 13 acquires the values in the first and second axes 31 and 32 corresponding to the position specified by the received instruction. This operation is performed in the same manner as in step S106.

Step S116 The calculation unit 14 calculates the value of the calculation result of the predetermined function based on the values in the first and second axes 31 and 32 acquired by the numerical value acquiring unit 13.

Step S117 The boundary value receiving unit 19 receives as the boundary value the value of the calculation result of the predetermined function provided by the calculation unit 14.

Step S118 The boundary modifying unit 20 modifies the nomogram image data such that the graph with the predetermined function having the boundary value becomes the boundary of the regions. The generation method of a new boundary is identical to the generation method of the new graph in step S113, and the discussion thereof is omitted herein. When the boundary line is moved, the erasing of the boundary line as a movement target (i.e., the boundary line before movement) is performed in the same manner as in the generation of the graph. If coloration or hatching is performed on a per region basis in the nomogram image data, the boundary modifying unit 20 modifies coloration or hatching as appropriate together with the modification of the boundary line. If a word describing the feature of the region (such as “overweight”) is displayed in the region, the boundary modifying unit 20 may modify the display position of the word in response to the modification of the boundary line. For example, the center of gravity of each region may be the display position of the word. If the boundary line is modified, the boundary modifying unit 20 may calculate the center of gravity of each new region, and may modify the nomogram image data such that the word is displayed at the center of gravity of the new region. Processing returns to S102.

Step S119 The instruction receiving unit 12 determines whether a instruction to generate the difference information has been received. If a instruction to generate the difference information has been received, processing proceeds to S120. If a instruction to generate the difference information has not been received, processing proceeds to S122.

Step S120 The difference information generation unit 21 generates, as the difference information, information related to a difference between the values in the first axis 31 of the position of the point graphic 41 and the target region, and/or a difference between the values in the second axis 32 of the position of the point graphic 41 and the target region. In the generation of the difference information, a method of acquiring the values in the first axis 31 of the position of the point graphic 41 and the target region, and/or the values in the second axis 32 of the position of the point graphic 41 and the target region is described below. It is assumed that an equation of the target region is stored on the unillustrated recording medium. The equation may be as follows:

a<F(x,y)<b

F(x, y) is a predetermined function with a value “x” in the first axis 31 and a value “y” in the second axis 32 serving as arguments (such as a BMI function in FIG. 4). The difference information generation unit 21 acquires coordinate values of the point graphic 41 in the screen coordinates, and converts the coordinate values into coordinate values in the client coordinates. The difference information generation unit 21 further converts the coordinate values in the client coordinates into values in the first and second axes 31 and 32. The values in the first and second axes 31 and 32 may now be (α, β). The difference information generation unit 21 then substitutes (α, β) in the predetermined function F(x, y) to calculate the value of F(α, β). Each of the three cases of the calculation is described as below.

(1) In the Case of F(α, β)<a

In this case, the values in the first and second axes 31 and 32 are determined within a range from the point graphic 41 to the boundary of F(x, y)=a. Discussed first is the case in which a change in the value to the boundary along the first axis 31 is calculated by varying the value in the first axis 31, i.e., by varying “x” only toward the boundary. In terms of the value in the second axis 32, the coordinate values (α, β) of the point graphic 41 and the coordinate value serving as a target remain unchanged. By solving F(x, β)=a, the value in the first axis 31 on the boundary is calculated. It is here assumed that the solution of F(x, β)=a is x=A. A target region (more precisely, an end point of the target region) is reached by varying the value in the first axis 31 from α to A. The difference information generation unit 21 determines that the target region is reached by changing the value in the first axis 31 by (A−α).

Similarly, a change in the value to the boundary along the second axis 32 is calculated by varying the value in the second axis 32, i.e., by varying “y” only toward the boundary. In terms of the value in the first axis 31, the coordinate values (α, β) of the point graphic 41 and the coordinate value serving as a target remain unchanged. By solving F(α, y)=a, the value in the second axis 32 on the boundary is thus calculated. It is assumed that the solution of F(α, y)=a is y=B. The target region (more precisely, an end point of the target region) is reached by varying the value in the second axis 32 from β to B. The difference information generation unit 21 determines that the target region is reached by changing the value in the second axis 32 by (B−β).

Similarly, changes in the values to the boundary along the first and second axes 31 and 32 are calculated by varying the values in the first and second axes 31 and 32, i.e., by varying both “x” and “y” to the boundary in a fashion similar to the way described above. Since there are an infinite number of combinations of changes along the first and second axes 31 and 32 to reach the boundary from the point graphic 41, some condition needs to be set up. For example, the value in the first axis 31 on the boundary may be pre-determined. The value in the second axis 32 on the boundary may be pre-determined. The gradient of a straight line from the point graphic 41 to the boundary may be pre-determined. Another condition may be pre-determined. If the value in the first axis 31 or the value in the second axis 32 on the boundary is pre-determined, the value in the other axis may be determined as described above. The changes needed in the values in the first and second axes 31 and 32 are thus determined. If the gradient of the straight line from the point graphic 41 is known, the intersection of the line passing through the position of the point graphic 41 with the boundary is calculated. The changes needed in the values in the first and second axes 31 and 32 are thus determined.

(2) In the Case of a≦F(α, β)≦b

In this case, the point graphic 41 is already positioned within the target region or on the end point of the target region. This frees the difference information generation unit 21 from acquiring the change in the first axis 31 to the target region and/or the change in the second axis 32 to the target region. In this case, the difference information generation unit 21 may generate the difference information to the effect that no difference is present, or may not generate the difference information at all. In the former case, the difference information to the effect that no difference is present is pre-stored on the unillustrated recording medium, and the difference information may be generated by reading the difference information from the recording medium.

(3) In the Case of F(α, β)>b

In this case, the changes in the values in the first and second axes 31 and 32 from the point graphic 41 to the boundary of F(x, y)=b are determined. The method for this determination remains unchanged from the case of F(α, β)<a except that F(x, y)=a is replaced with F(x, y)=b. The detailed discussion thereof is omitted here.

In the case of F(α, β)<a or F(α, β)>b, the changes in the values in the first and second axes 31 and 32 from the point graphic 41 to the boundary are calculated, and the calculated changes themselves may be treated as the difference information. Alternatively, information related to the calculated changes may be treated as the difference information. The related information in the nomogram for BMI calculation may be an amount of exercise or calorie consumption responsive to a change in the weight needed to reach a “normal” region as a target from the position of the point graphic 41. These values may be calculated by calculating a function with the weight serving as an argument.

The boundary may be modified with the target region defined as a<F(x,y)<b as described above. In response to the modification of the boundary, the values of a and b are also modified.

The changes in the values in the first and second axes 31 and 32 from the position of the point graphic 41 to the boundary determined described above could be inappropriate. For example, the weight may become a negative value, or an abnormally large value. In such a case, the difference information generation unit 21 may not generate the difference information based on such a value.

Step S121 The image generation unit 15 generates the difference information image data based on the difference information generated by the difference information generation unit 21. The image generation unit 15 may generate the difference information image data by reading, as source image data, image data of a graphic such as a frame pre-stored on the unillustrated recording medium, and by setting difference information in text in the image data. The image generation unit 15 may set the display position of the difference information close to the point graphic 41. Processing returns to step S102.

Step S122 The image display unit 16 determines whether to end displaying the nomogram image data or the like. If the displaying of the nomogram image data is to end, processing returns to step S101. If the displaying of the nomogram image data is not to end, processing returns to step S103. Upon receiving an instruction to end displaying the nomogram image data or the like, the image display unit 16 may determine that the displaying of the nomogram image data or the like is to end. Alternatively, the image display unit 16 may determine that the displaying of the nomogram image data or the like is to end if a predetermined period of time has elapsed since the last displaying of the image data.

The process in the flowchart of FIGS. 2 and 3 is terminated by a power-off operation or a process end interruption.

Operation of the electronic nomogram 1 of the embodiment is described with reference to a specific example. In the specific example, the image display unit 16 displays each piece of the image data on a display.

The user may now operate the mouse or the keyboard to input on the electronic nomogram 1 an instruction to output the nomogram 30. The image display unit 16 determines that it is time to display the image data (step S101). The image display unit 16 reads the nomogram image data and outputs the read nomogram image data to the display (step S102). As a result, the nomogram 30 of FIG. 4 is displayed on the display screen of the display with none of the point graphic 41, the first and second dropline graphics 42 and 43, the first and second numerical values 44 and 45, and the calculation result 46.

The user may now operate the mouse to click on one point on the nomogram 30 displayed on the display. The instruction receiving unit 12 then determines that an instruction specifying the position of the point graphic 41 has been received (step S103). The image generation unit 15 generates the point graphic image data at the position that has been mouse-clicked (step S104). It is assumed here that the position with a height of “170 (cm)” and a body weight of “85.0 (kg)” has been clocked on. The image generation unit 15 generates as the first and second dropline graphic image data the image data of the first and second dropline graphics 42 and 43 respectively perpendicularly extending to the first and second axes 31 and 32 from the point graphic 41 (step S105).

The numerical value acquiring unit 13 acquires the first numerical value “170” and the second numerical value “85.0” corresponding to the point graphic 41 on the nomogram (step S106). The calculation unit 14 calculates the value of the calculation result of the predetermined function, i.e., the value of BMI (step S107). The equation used in this calculation is:

BMI=(second numerical value)/(first numerical value/100)2

If the first and second numerical values are those described above, the value of BMI is “29.4.”

The image generation unit 15 then generates the calculation result image data. More specifically, the image generation unit 15 generates the first and second numerical image data corresponding to the first and second numerical values acquired by the numerical value acquiring unit 13. The image generation unit 15 generates the calculation result image data responsive to the value of BMI calculated by the calculation unit 14 (step S108).

The image display unit 16 displays, on a display screen thereof, the image data such as the point graphic 41 generated by the image generation unit 15 (step S102). As a result, the display illustrated in FIG. 4 is presented.

The position of the point graphic 41 may not be the position the user intends. For example, the operation described below may be performed if the user wants to know the degree of overweight with the value of the height being “174 (cm)” and the value of the body weight being “86.6 (kg).” In the display of FIG. 4, the user may move the point graphic 41 by dragging the point graphic 41 with the mouse or the like or by clicking on a new point on a nomogram 30 as a target with the mouse or the like. The image generation unit 15 generates at the position after movement the point graphic image data and the first and second dropline graphic image data (steps S103-S105). The numerical value acquiring unit 13 acquires the first and second numerical values corresponding to the position of the point graphic 41 (step S106). The calculation unit 14 calculates the value of BMI based on the acquired first and second numerical values (S107). The image generation unit 15 generates the first and second numerical image data and the calculation result image data (step S108). These pieces of data are displayed on the display (step S102). The point graphic 41 is moved at a time in the process described above. The point graphic 41 may not necessarily be moved at a time. For example, the image display unit 16 may successively display the track of the point graphic 41 being dragged in the course of the movement thereof. The point graphic 41 may be moved by repeating steps S102-S108.

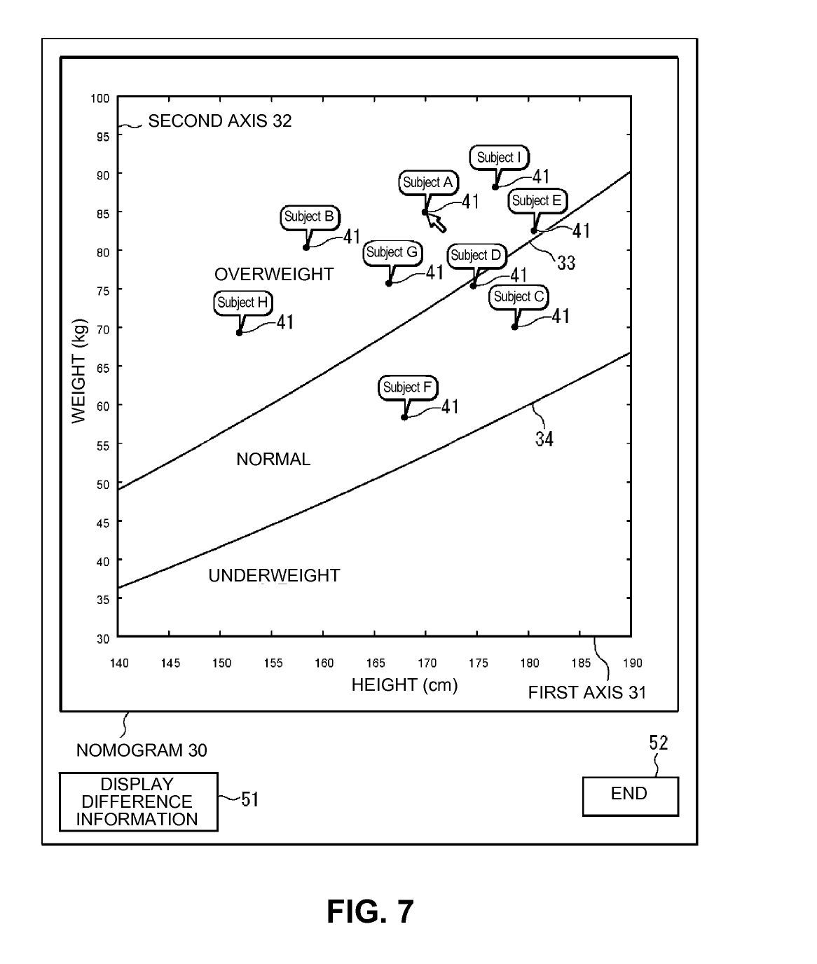

The displaying process of the point graphic 41 is described below. A plurality of point graphics 41 are displayed in response to the targets defined by the values in the first and second axes 31 and 32 (more specifically, the subjects of BMI). In such a case, a new point graphic 41 may be generated by clicking on a point on the nomogram 30. To move an existing point graphic 41, a drag operation is performed. If the point graphics 41 of heights and body weights of a plurality of subjects are displayed, the user inputs the point graphic 41 on a per subject basis (steps S103-S108, and S102). If the position of the point graphic 41 is not the position the user intends, the position of the point graphic 41 is modified as described above. If a plurality of point graphics 41 are displayed, the user may be at a loss for which point graphic 41 corresponds to a subject. As illustrated in FIG. 7, the user name corresponding to a point graphic 41 may be input in a popup bubble extending from the point graphic 41. In such a case, the image generation unit 15 generates image data of the popup bubble corresponding to the point graphic 41, and the image display unit 16 displays the image data of the popup bubble. The instruction receiving unit 12 may also receive the user name to be displayed in the popup bubble.

As illustrated in FIG. 7, the popup bubble of each point graphic 41 allows the user corresponding to the point graphic 41 to be identified. The shape of the point graphic 41 may be set to be different. For example, the point graphics 41 may be ∘ (circle), □ (square), ⋄ (rhombus), and the like, and the user names corresponding to the point graphics 41 may be described as below:

∘ (circle): Subject A

□ (square): Subject B

⋄ (rhombus): Subject C

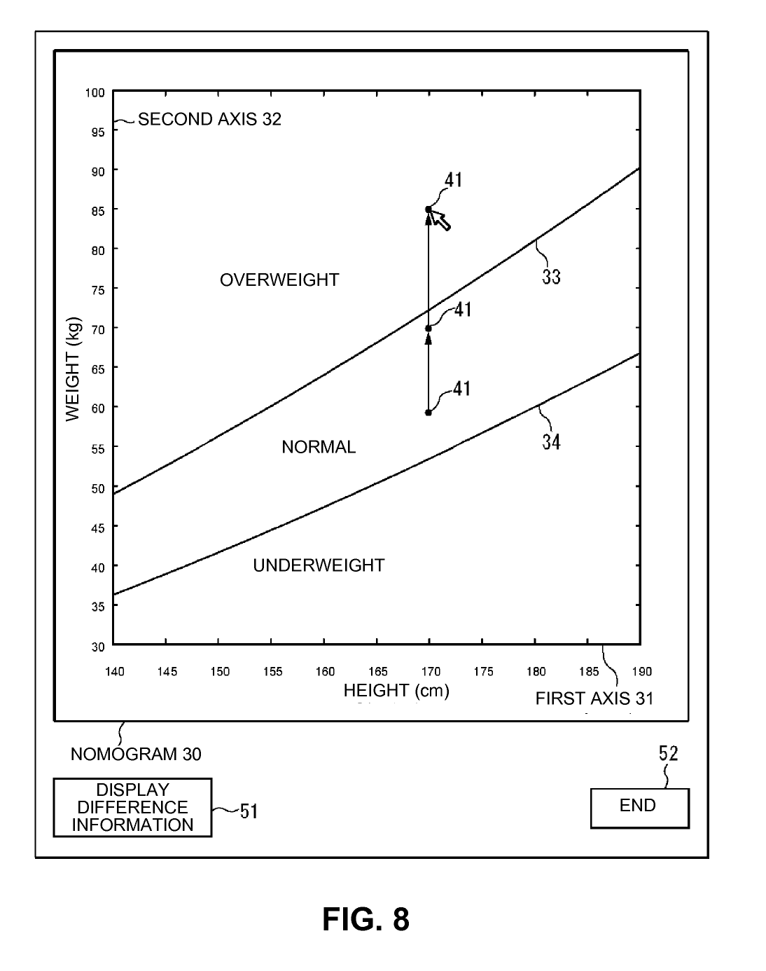

Discussed below is the case in which a plurality of displayed point graphics 41 correspond to a history of the same target (the subject of BMI) defined by the values in the first and second axes 31 and 32. It is assumed in this case that the point graphics 41 are input in the order of history from old to new graphics. As illustrated in FIG. 8, the image generation unit 15 generates image data of an arrow-headed line connecting the point graphics 41, and the image display unit 16 then displays the image data of the arrow-headed line. As a result, a person who views the display of FIG. 8 can know how a user of interest has changed in the values of his or her height and body weight. When the history is displayed, the date and year of the data corresponding to each point graphic 41 may be displayed in the same manner as the popup bubble of FIG. 7. With this arrangement, the user can know more detailed information about the history of the point graphics 41 displayed on the nomogram 30. In such a case, the instruction receiving unit 12 may receive information about the date and year, and the image generation unit 15 may generate image data of the popup bubble including the date and year.

Discussed below is the case in which a graph according to which the predetermined function provides an intended function value is displayed on the nomogram 30. If an intended graph is to be displayed on the nomogram 30, the user specifies the position where the graph is to be displayed using a pointing device such as a mouse. In order to clarify that the click operation to specify the position here is different from a click operation to specify the position of the point graphic 41, the mouse may be clicked after switching an input mode to a graph input mode using unillustrated means. Alternatively, the specifying of the position of the point graphic 41 may be performed by clicking and the specifying of the position of the graph may be performed by double clicking.

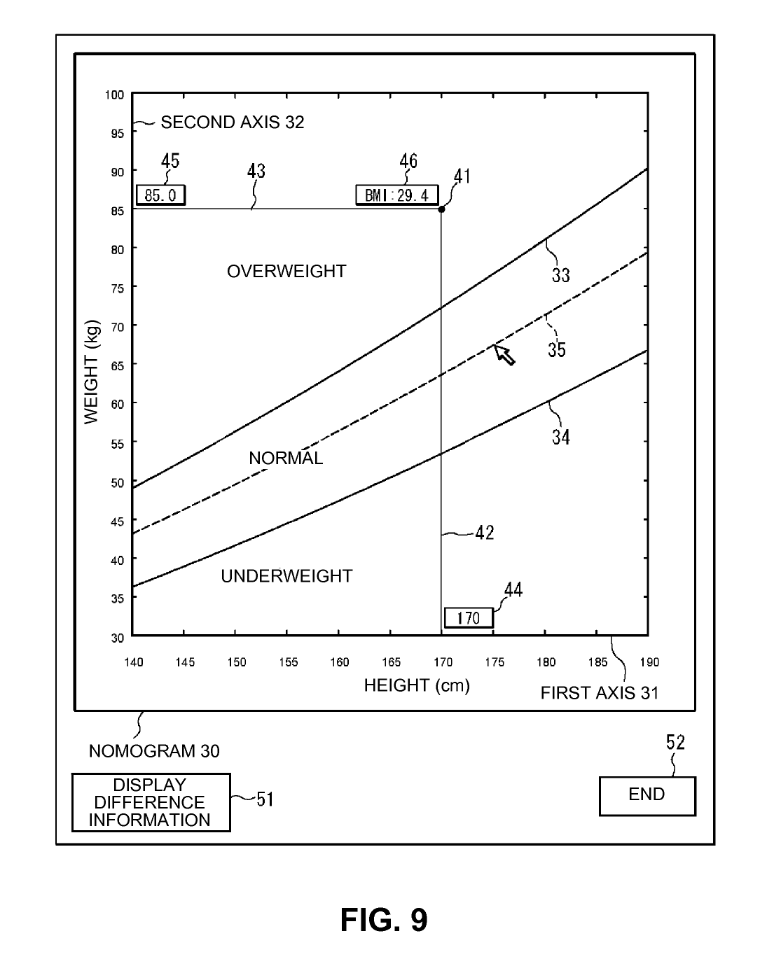

With the nomogram 30 displayed as illustrated in FIG. 4, the user may now specify the position of a height of 175 cm and a body weight of 67.375 kg on the nomogram 30 using the pointing device. The instruction receiving unit 12 then receives the specified position (step S109), and the numerical value acquiring unit 13 acquires the value of a height of “175 (cm)” and a weight of “67.375 (kg)” corresponding to the specified position (step S110). The values of the height and the body weight are then transferred to the calculation unit 14, and the calculation unit 14 calculates a BMI value based on these values (step S111). In this case, BMI is BMI=“22.0” and becomes a function value. The function value “22.0” is transferred to the function value receiving unit 17 (step S112). The graph generation unit 18 generates a graph of BMI responsive to the function value “22.0” received by the function value receiving unit 17, and then adds the graph to the nomogram image data stored on the image data storage unit 11 (step S113). A broken-line graph of BMI=22.0 may be generated and added to the nomogram image data. As illustrated in FIG. 9, a new graph 35 is thus displayed on the nomogram 30 (step S102). In this way, the graph 35 having a normal BMI (=22.0) is added on the nomogram. The BMI value “22.0” corresponding to the graph 35 may be displayed in a mapped state with the graph 35 in FIG. 9. In such a case, the image generation unit 15 receives the value “22.0” as the calculation result of the predetermined function from the calculation unit 14, generates an image responsive to the value, and displays the value in a mapped state with the graph 35. For example, the displaying of the value in the mapped state with the graph 35 may be the displaying of the value on the graph 35. Alternatively, a leading line is extended from the graph 35 and the value may be displayed at the other end of the leading line from the graph 35.

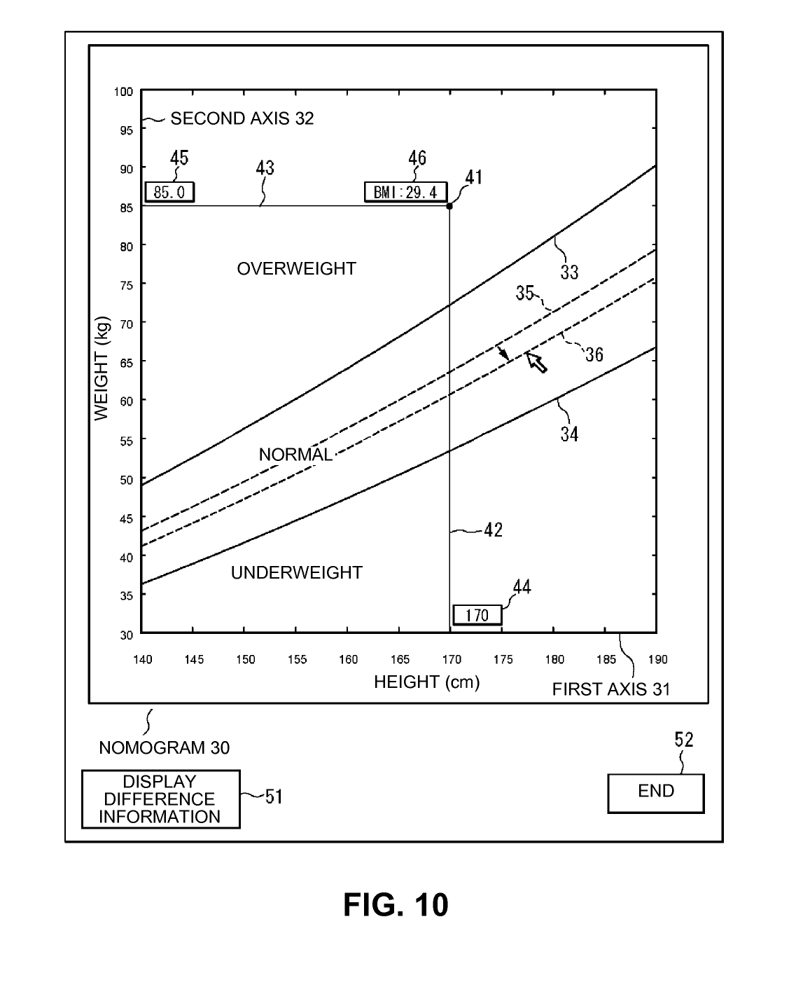

To move the graph 35, the user may drag the graph 35 to any location using the pointing device such as a mouse. The instruction receiving unit 12 receives a drag instruction (step S109), and a new graph 36 is generated at a position as a drag destination in a fashion similar to that described above as illustrated in FIG. 10 (steps S110-S113, and S102). For convenience of explanation, the graph 35 is also illustrated in FIG. 10, but the graph generation unit 18 deletes from the nomogram image data the graph 35 serving as the start point of the drag operation after the new graph 36 is added to the nomogram image data. The graph of the nomogram is moved in this way.

The movement of the boundary that partitions the nomogram into a plurality of regions is described below. To move an intended boundary, the user specifies the boundary to be moved using the pointing device such as a mouse. The user then specifies a movement destination of the boundary using the pointing device such as a mouse. The specifying of the movement destination may be performed through a mouse drag operation or other operation. More specifically, the boundary to be moved is dragged to the desired movement destination.

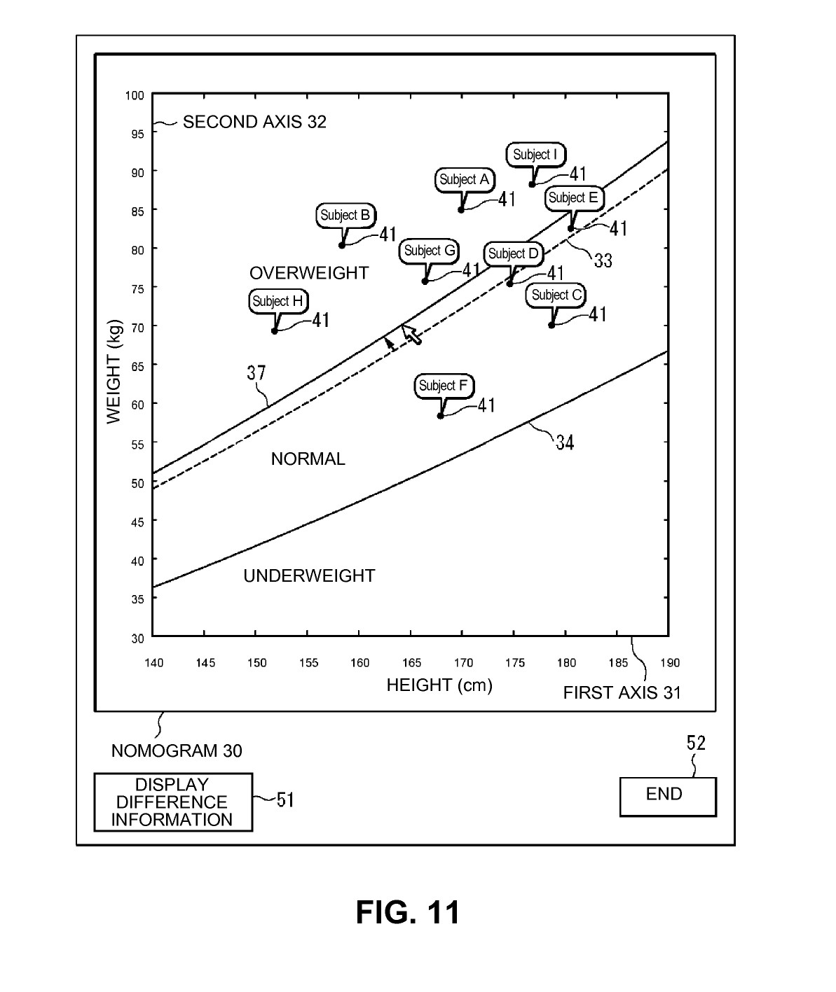

The nomogram 30 with the boundary thereof before movement may be something like the one illustrated in FIG. 7. A health guidance program may now be provided to five subjects belonging to the overweight region. As illustrated in FIG. 7, six subjects belong to the overweight region, and the user drags the first region boundary line 33 such that the subject closest to the normal region belongs to the normal region. The drag operation is received by the instruction receiving unit 12 (step S114), and the numerical value acquiring unit 13 acquires the values of the height and the body weight at the position after the drag operation (step S115). The values of the height and the body weight are transferred to the calculation unit 14. The calculation unit 14 calculates a value of BMI based on these values (step S116), and then transfers the value of BMI to the boundary value receiving unit 19. Upon receiving as the boundary value the value of BMI, the boundary value receiving unit 19 transfers the boundary value to the boundary modifying unit 20 (step S117). As illustrated in FIG. 11, the boundary modifying unit 20 modifies the nomogram image data such that the first region boundary line 33 is shifted in position to a first region boundary line 37 as a new line (step S118). A modified nomogram 30 is thus displayed (step S102). Although the first region boundary line 33 is denoted by a broken line in FIG. 11 for convenience of explanation, the first region boundary line 33 is not displayed in practice after being moved. In this way, the normal region includes a subject “E,” and the five subjects belong to the overweight region. The five subjects are thus guided in accordance with the health guidance program.

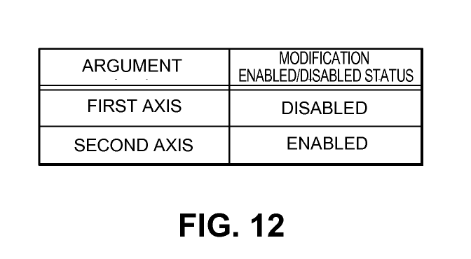

The difference information is displayed as described below. The following discussion is based on the premise that modification enabled/disabled information representing whether each argument is modifiable in an arbitrary manner is stored on the unillustrated recording medium in the electronic nomogram 1. FIG. 12 illustrates an example of the modification enabled/disabled information. As illustrated in FIG. 12, an argument and a modification enabled/disabled status thereof are mapped to each other. More specifically, the argument in the first axis 31 (more specifically, the height) is modification-disabled, and the argument in the second axis 32 (more specifically, the body weight) is modification-enabled. It is generally considered that a subject can intentionally control his or her body weight by controlling calorie intake and the amount of exercise, but cannot control his or her height at will.

In the specific example, the normal region is set to be 18.5<BMI<25. The following equation representing the normal region may be stored on the unillustrated recording medium:

18.5<(value in the second axis)/(value in the first axis/100)2<25

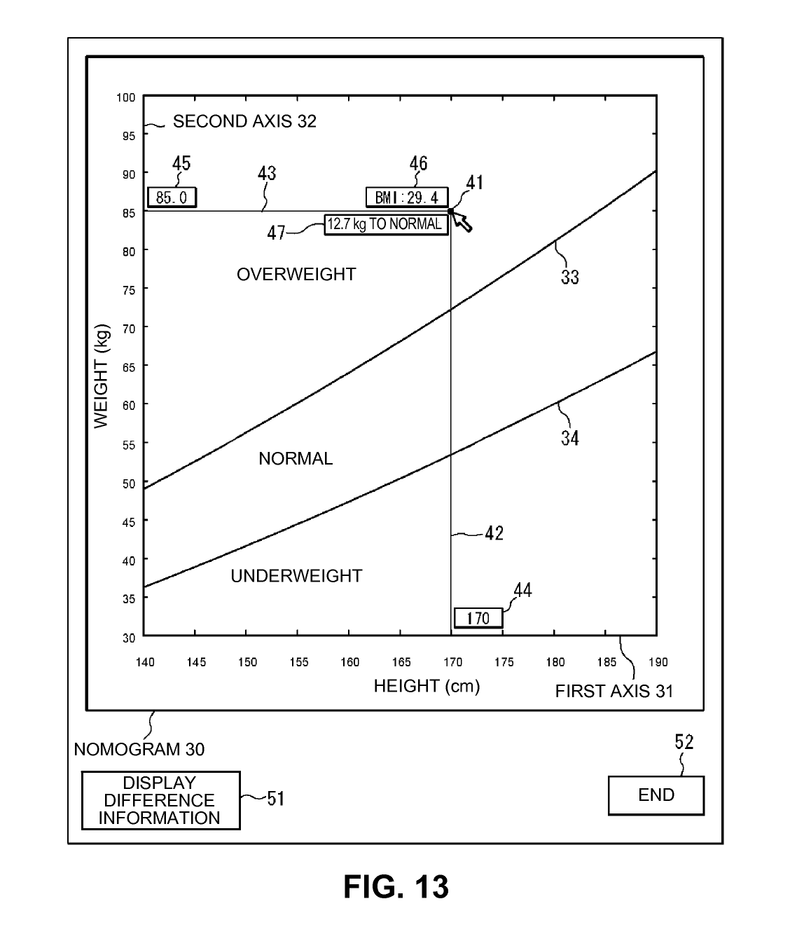

With the nomogram 30 of FIG. 4 displayed, the user may now click on a “display difference information” button by operating the pointing device such as a mouse. The instruction receiving unit 12 receives the instruction, and transfers the instruction to display the difference information to the difference information generation unit 21 via an unillustrated line (step S119). The difference information generation unit 21 references the modification enabled/disabled information illustrated in FIG. 12 and learns that the value in the second axis 32 only is modifiable. As described above, the difference information generation unit 21 determines that the position of the point graphic 41 is close to the first region boundary line 33 with BMI=25, and calculates a change in the value in the second axis 32 to reach BMI=25. In this case, the change in the value in the second axis 32 is 12.7 (kg). The difference information generation unit 21 thus generates the difference information to the effect that the change to the normal region is 12.7 (kg) (step S120). The image generation unit 15 then generates the difference information image data responsive to the generated difference information (step S121). The difference information image data is displayed as illustrated in FIG. 13. Viewing the display, the user corresponding to the point graphic 41 may learn that if the user loses weight by 12.7 (kg), his or her weight reaches the normal region.

As described above, the difference information such as calorie intake or the like corresponding to the value of weight may be generated and then displayed instead of the value of weight to reach the normal region. For example, calories of body fat is about 7 kcal/1 g in view of water contained in a body fat tissue. Body fat of 12.7 (kg) corresponds to 88900 (kcal). The difference information generation unit 21 may generate the difference information indicating how much decrease in calorie intake achieves the target as the normal region or how much increase in consumed calories achieves the target as the normal region.

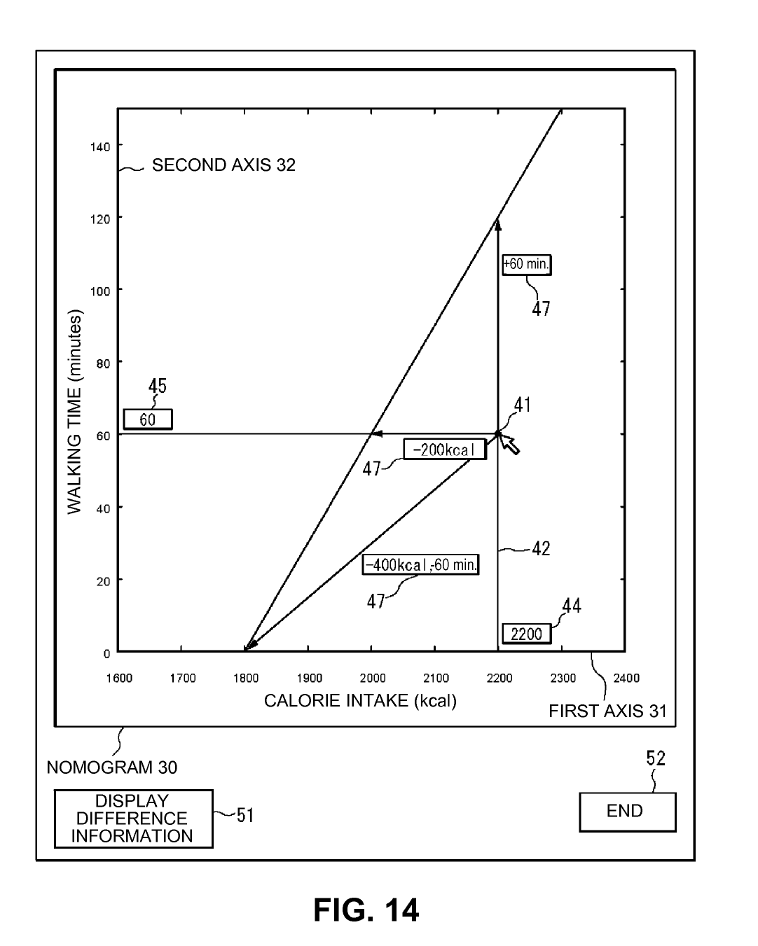

The difference information is generated as described below based on the assumption that the modification enabled/disabled information indicates that both the values in the first and second axes 31 and 32 are modifiable. In the nomogram 30 illustrated in FIG. 14, the first axis 31 represents calorie intake of calories taken by the subject at meal, and the second axis 32 represents walking time of the subject. With 60 minutes of walk corresponding to 200 kcal, a line of 1800 kcal is drawn which represents a value that is obtained by subtracting consumed calories from the calorie intake. The line represents a daily calorie balance of 1800 (kcal), and is a target region.

Three types of difference information are calculated in the specific example. The three types of difference information include only a change in the value in the first axis 31 to reach the normal region, only a change in the value in the second axis 32, and only changes in the values in the first and second axes 31 and 32 to reach the normal region with walking time=0.

The point graphic 41 may now be at a calorie intake of “2200 (kcal)” and a walking time of “60 (minutes)” as illustrated in FIG. 14. At the position of the point graphic 41, a daily calorie balance of 2000 (kcal) is obtained by subtracting 200 (kcal) for a walking time of 60 minutes from 2200 (kcal). If the user clicks on a “display difference information” button 51 using the pointing device such as a mouse, the instruction receiving unit 12 receives the corresponding instruction and then transfers the instruction to display the difference information to the difference information generation unit 21 via an unillustrated line (step S119). The difference information generation unit 21 references the modification enabled/disabled information and learns that the values in the two axes are modifiable. As described above, the difference information generation unit 21 calculates the calorie intake to reach the normal region by changing calorie intake only, the walking time to reach the normal region by changing walking time only, and the calorie intake and the walking time to reach the normal region with the walking time being zero (minutes) by changing calorie intake and walking time, and then generates the difference information related to these values (step S120). The image generation unit 15 generates the difference information image data responsive to each piece of the difference information, and generates the image data of an arrow headed line with the position of the point graphic 41 as a start point and the destination position as an end point reached through the change indicated by the difference information (step S121). These pieces of information are displayed as illustrated in FIG. 14. A method of reducing the daily energy balance from 2000 (kcal) to 1800 (kcal) is displayed. The difference information image data is preferably displayed close to or on the arrow-headed line. For example, the difference information image data may be displayed at a point that internally divides with a predetermined ratio the length between the position of the point graphic 41 and the destination position indicated by the difference information image data. The internally dividing point may be at the center between the position of the point graphic 41 and the destination position.

With the display of FIG. 14 presented, the user learns that the daily calorie balance can be reduced to 1800 (kcal) by reducing the calorie intake by 200 kcal, by increasing the walking time by 60 minutes, or by reducing the calorie intake by 400 kcal and the walking time by 60 minutes. The displaying of at least two pieces of the difference information image data allows the subject to select an optimum solution. For example, if the subject is too busy with work to have time for exercise, the subject may select a method that does not increase exercise time.

If the user clicks on an “end” button 52 in the display of FIG. 4 or the like, the displaying of the nomogram 30 or the like quits, and no display appears (step S122).

Only the process of displaying the difference information is discussed in this example. If the displaying of the difference information becomes unnecessary, an instruction not to display the difference information is input through an unillustrated method, and the difference information ceases to be displayed in response to the input instruction. For example, the image generation unit 15 may delete the difference information image data such that the difference information ceases to be displayed.

As described above, the electronic nomogram 1 of the embodiment provides higher user friendliness than the related art nomogram. For example, since the position of the point graphic 41 displayed on the nomogram is specified using the GUI instead of the text input of the position, the numerical values such as the values of height and body weight may be input and the input numerical values may be modified using the pointing device only. This arrangement eliminates the need to use a plurality of types of input devices such as both the pointing device and the keyboard. If a numerical value is text input, the number of digits is typically limited. If a numerical value is input using the GUI, the numerical value may be input in an arbitrary fashion with no such a limit imposed. Unlike the technique disclosed in the above-described non-patent document 2, the point graphic 41 is free from moving in tandem with the mouse pointer, another operation may be performed with the point graphic 41 remaining displayed at a desired position.

Since the value of the calculation result of the predetermined function is displayed, the user can easily learn the calculation result of the predetermined function corresponding to the position of the point graphic 41.

Since the first and second numerical values corresponding to the position of the point graphic 41 are displayed, the user can learn precise values in the first and second axes 31 and 32 corresponding to the position of the point graphic 41. The graph with the predetermined function having the desired function value may be displayed on the nomogram as necessary. When the nomogram is partitioned into a plurality of regions in accordance with the value of the predetermined function, the position of the boundary of the regions may be modified as necessary.

The difference information as information related to a change from the position of the point graphic 41 to the target region may be generated and displayed. The user can easily learn based on the difference information how much change is needed to reach the target region.

A plurality of point graphics 41 may be displayed. For example, a plurality of point graphics 41 corresponding to a plurality of subjects may be displayed on the nomogram to compare the subjects. A plurality of point graphics 41 corresponding to a history of the same subject may be displayed on the nomogram to view a change in the data of the subject.

If the nomogram is partitioned into a plurality of regions with a plurality of point graphics displayed on the nomogram, the image generation unit 15 may generate the point graphic image data such that the point graphics 41 displayed in different regions are displayed as visually different graphics. The visually different graphics may be graphics different in shape, different in color, different in display fashion (such as blinking or not, or rotated or not), and different in other visual effect. For example, the point graphic 41 in the overweight region may be square in shape, the point graphic 41 in the normal region may be circular in shape, and the point graphic 41 in the underweight region may be triangular in shape. To display the point graphic 41 in a fashion different from region to region, information identifying each region (for example, information such as the first region being a<F(x,y)<b, the second region being b<F(x,y)<c, and the like) may be stored on the unillustrated recording medium. Information mapping a region to the display of the point graphic 41 (for example, information of the point graphic 41 in the first region being square in shape, the point graphic 41 in the second region being triangular in shape, and the like) may be stored on the unillustrated recording medium. The image generation unit 15 references the information identifying each region, identifies the region having the point graphic 41 therewithin based on the first and second numerical values of the point graphic 41, and then generates the point graphic image data. The image generation unit 15 also references the information mapping each region to the display of the point graphic 41, identifies the display method responsive to the identified region, and then generates the point graphic image data such that the point graphic 41 is displayed in accordance with the identified display method. If a single point graphic 41 is displayed, the point graphic 41 may be displayed in a fashion different from region to region. Viewing the point graphic 41, the user may easily learn which region the point graphic 41 is positioned in, or may easily check whether the point graphic 41 is present within the same region of another point graphic 41.

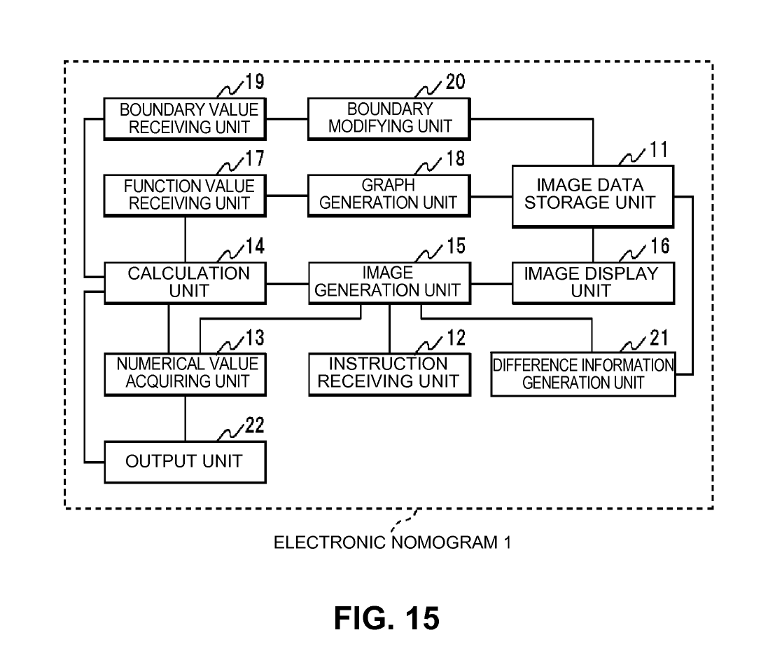

As illustrated in FIG. 15, the electronic nomogram 1 of the embodiment may further include an output unit 22 for outputting the first and second numerical values acquired by the numerical value acquiring unit 13 and the value of the calculation result of the predetermined function calculated by the calculation unit 14. The output unit 22 may output only the first and second numerical values, only the value of the calculation result, or both. The output may be displayed on a display device (such as a CRT display, or a liquid-crystal display), may be transmitted to a predetermined device via a communication line, may be printed on a printer, may be output in audio to a loudspeaker, may be stored on a recording medium, or may be transferred to another element. If the output unit 22 transfers the output to another element, one of the image generation unit 15, the function value receiving unit 17, and the boundary value receiving unit 19 may receive from the output unit 22 the first and second numerical values and the value of the calculation result of the predetermined function. The output unit 22 may or may not include a device for outputting (such as a display device, or a printer). The output unit 22 may be implemented based on hardware, or based on software such as a driver for driving a predetermined device.

If the electronic nomogram 1 includes the output unit 22, the output unit 22 outputs the first and second numerical values and the value of the calculation result. The output unit 22 may accumulate the first and second acquired numerical values and the acquired value of the calculation result in the electronic medical record of each subject, or may transmit the first and second acquired numerical values and the acquired value of the calculation result to a server that manages these pieces of information.

According to the embodiment, the electronic nomogram 1 also displays the difference information as described above. The electronic nomogram 1 may not display the difference information. If the difference information is not displayed, the electronic nomogram 1 does not need the difference information generation unit 21 and each element is freed from the process related to the difference information.

If the nomogram is partitioned into a plurality of regions in the embodiment, the boundary is modifiable. The boundary may not be modifiable. If the boundary of the region is not modified, the boundary value receiving unit 19 and the boundary modifying unit 20 are not needed in the electronic nomogram 1. Each element is freed from the process related to the modification of the boundary.

The graph responsive to the received function value is displayed in the embodiment. The graph may not be displayed. If the graph responsive to the received function value is not displayed, the function value receiving unit 17 and the graph generation unit 18 are not needed in the electronic nomogram 1. Each element is freed from the process related to the displaying of the graph.

The first and second numerical values are displayed on the nomogram in the embodiment. The first and second numerical values may not be displayed.

The calculation result is displayed on the nomogram in the embodiment. If the electronic nomogram 1 includes the output unit 22, the calculation result may not be displayed on the nomogram.

The nomogram image data may be partitioned into a plurality of regions in accordance with the value of the calculation result of the predetermined function in the embodiment. The number of regions is not limited to any particular number. In the embodiment described above, the nomogram image data may be partitioned into three regions, or into regions of another number, for example, two regions or four regions. The nomogram image data may not be partitioned into a plurality of region.

The electronic nomogram 1 is standalone in the discussion of the embodiment. The electronic nomogram 1 may be a standalone apparatus or a server apparatus in a server-client system. In the latter case, the receiving unit and the output unit may receive an input and may output information via a communication line.

Each process or each function may be centralized-processed by a single apparatus or a single system in the embodiment. Alternatively, each process or each function may be decentralized-processed by a plurality of apparatuses or a plurality of systems.

In the embodiment, the information related to the process performed by each element of the nomogram may be stored on the unillustrated recording medium temporarily or for a long-term period even if the storage of the information related to the process is not expressly described in the above discussion. For example, the information related to the process may include information received, acquired, selected, generated, transmitted or received by each element, and information such as a threshold value, equation, and addresses used in the process of each element. The storage of the information onto the unillustrated recording medium may be the storage of the information on each element or an unillustrated storage unit. The reading of the information from the unillustrated recording medium may be carried out by each element or an unillustrated reading unit.

In the embodiment, the information used in each element may be modified as appropriate by the user on condition that the information is modifiable by the user even if such a modification by the user is not expressly described in the above discussion. For example, the information used in each element may include information such as the threshold value, the address, and a variety of set values used in each element. The information used in each element may not be modified. If these pieces of information are modifiable, the modification thereof may be performed by an unillustrated receiving unit receiving a modification instruction from the user, and an unillustrated modifying unit modifying the information in response to the modification instruction. The unillustrated receiving unit for receiving the modification instruction may receive the instruction from an input device, may receive the information transmitted via the communication line, or may receive the information read from the predetermined recording medium.

In the embodiment, two or more elements may be physically integrated into a unitary device or separated as different devices if at least two elements included in the electronic nomogram 1 have a communication device, an input device, and the like.

In the embodiment, each element may be implemented based on dedicated hardware, or software. An element implementable with software may be implemented by executing a program. For example, each element may be implemented by a program executor, such as CPU, which reads a software program from a recording medium such as a hard disk or a semiconductor memory and executes the software program. The software programs implementing the electronic nomogram 1 of the embodiment may include the programs described below. The program causes a computer to perform as an instruction receiving unit for receiving an instruction specifying a position of a point graphic displayed on a nomogram and used to indicate a position on the nomogram, the nomogram with a coordinate plane having a first axis and a second axis, a numerical value acquiring unit for acquiring first and second numerical values, the first and second numerical values being respectively first and second axis values corresponding to the position of the point graphic on the nomogram, a calculation unit for calculating a value of a calculation result of a predetermined function that uses as arguments the first and second numerical values acquired by the numerical value acquiring unit, an image generation unit for generating as point graphic image data, image data of the point graphic, at a position specified by the instruction received by the instruction receiving unit and generating, as calculation result image data, image data of the value of the calculation result calculated by the calculation unit, and an image display unit for displaying the nomogram image data read from the image data storing unit storing as the nomogram image data the image data of the nomogram, and the point graphic image data and the calculation result image data generated by the image generation unit.

Another software program implementing the electronic nomogram 1 of the embodiment is described below. The program causes a computer to perform as an instruction receiving unit for receiving an instruction specifying a position of a point graphic displayed on a nomogram and used to indicate a position on the nomogram, the nomogram with a coordinate plane having a first axis and a second axis, a numerical value acquiring unit for acquiring first and second numerical values, the first and second numerical values being respectively first and second axis values corresponding to the position of the point graphic on the nomogram, a calculation unit for calculating a value of a calculation result of a predetermined function that uses as arguments the first and second numerical values acquired by the numerical value acquiring unit, an output unit for outputting the value of the calculation result of the function calculated by the calculation unit, an image generation unit for generating as point graphic image data, image data of the point graphic, at a position specified by the instruction received by the instruction receiving unit, and an image display unit for displaying the nomogram image data read from the image data storing unit storing as the nomogram image data the image data of the nomogram, and the point graphic image data generated by the image generation unit.

The functions performed by the program do not include any function that is performed by hardware only. For example, the functions performed by the program do not include the functions that are performed by hardware only, such as a modem and an interface card in the receiving unit receiving information, and in the display unit displaying information, and the like.

The program may be executed after being downloaded from a server or the like, or after being read from a predetermined recording medium (such as an optical disk like a CD-ROM, or a magnetic disk, or a semiconductor memory). The program may be the one included in a program product.

The program may be executed by a single computer or a plurality of computers. More specifically, the program may be executed through centralized processing or decentralized processing.

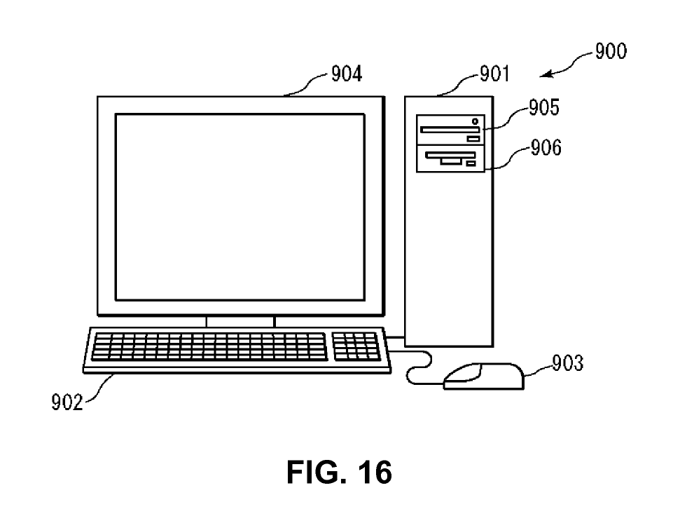

FIG. 16 is a diagrammatic view illustrating the appearance of the computer that implements the electronic nomogram 1 of the embodiment by executing the program. The embodiment may be implemented based on computer hardware and a software program running on the computer hardware.

A computer system 900 of FIG. 16 includes a computer 901 including a CD-ROM (Compact Disk Read Only Memory) drive 905, and an FD (Floppy (registered trademark) Disk) drive 906, a keyboard 902, a mouse 903, and a monitor 904.

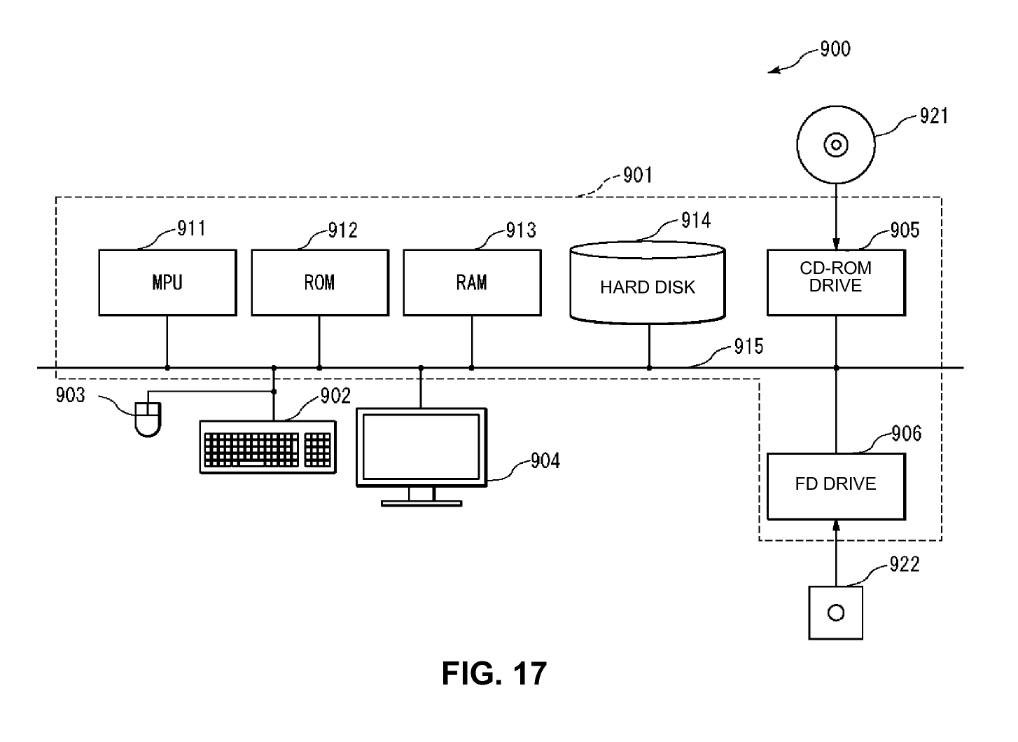

FIG. 17 illustrates an internal structure of the computer system 900. As illustrated in FIG. 17, the computer system 900 includes, in addition to the CD-ROM drive 905, and the FD drive 906, an MPU (Micro Processing Unit) 911, a ROM 912 storing programs such as a bootup program, a RAM (Random Access Memory) 913 connected to the MPU 911, temporarily storing an instruction of an application program and temporarily providing a memory space, a hard disk 914 storing the application program, a system program, and data, and a bus 915 interconnecting the MPU 911, the ROM 912, and the like. The computer 901 may include an unillustrated network card providing connection to a LAN.

The program causing the computer system 900 to perform the function of the electronic nomogram 1 of the embodiment may be stored on one of the CD-ROM 921 and the FD 922, which are respectively loaded onto the CD-ROM drive 905 and the FD drive 906. The program is thus transferred to the hard disk 914. Alternatively, the program may be transmitted to the computer 901 via an unillustrated network, and then stored onto the hard disk 914. The program, when executed, is loaded onto the RAM 913. The program may be loaded from the CD-ROM 921 or the FD 922, or directly via the network.

The program may not necessarily include an operating system (OS) causing the computer 901 to execute the function of the electronic nomogram 1 of the embodiment, a third-party program, or the like. The program may include only an instruction that calls an appropriate function (module) in a controlled manner, and achieves desired results. The operation of the computer system 900 is known, and the detailed discussion thereof is omitted herein.

The invention is not limited to the embodiment, and a variety of modifications are possible and fall within the scope of the invention.

### INDUSTRIAL APPLICABILITY

The electronic nomogram of the invention provides higher user friendliness than the related art nomogram, and finds applications as a device displaying a nomogram.

1. An electronic nomogram comprising:
an image data storing unit for storing, as nomogram image data, image data of a nomogram with a coordinate plane having a first axis and a second axis;
an instruction receiving unit for receiving an instruction specifying a position of a point graphic displayed on the nomogram and used to indicate a position on the nomogram;
a numerical value acquiring unit for acquiring first and second numerical values, the first and second numerical values being respectively first and second axis values corresponding to the position of the point graphic on the nomogram;
a calculation unit for calculating a value of a calculation result of a predetermined function that uses as arguments the first and second numerical values acquired by the numerical value acquiring unit;
an image generation unit for generating, as point graphic image data, image data of the point graphic at a position specified by the instruction received by the instruction receiving unit and generating, as calculation result image data, image data of the value of the calculation result calculated by the calculation unit; and
an image display unit for displaying the nomogram image data read from the image data storing unit, and the point graphic image data and the calculation result image data, generated by the image generation unit.

2. The electronic nomogram according to claim 1, wherein the image generation unit also generates, as first numerical image data, image data of the first numerical value acquired by the numerical value acquiring unit and, as second numerical image data, image data of the second numerical value acquired by the numerical value acquiring unit, and
wherein the image display unit also displays the first numerical image data and the second numerical image data.

3. The electronic nomogram according to claim 1, further comprising:
a function value receiving unit for receiving as a function value a value of the predetermined function; and
a graph generation unit for generating a graph in accordance with which the predetermined function provides the function value received by the function value receiving unit, and for modifying the nomogram image data such that the graph is displayed on the nomogram.

4. The electronic nomogram according to claim 3, wherein the instruction receiving unit receives an instruction specifying a position through which the graph of the predetermined function displayed on the nomogram runs;
wherein the numerical value acquiring unit acquires the first and second axis values corresponding to the position specified by the instruction received by the instruction receiving unit;
wherein the calculation unit calculates the predetermined function that uses as the arguments the first and second numerical values, corresponding to the position specified by the instruction received by the instruction receiving unit, and acquired by the numerical value acquiring unit to obtain the value of the calculation result of the function; and
wherein the function value receiving unit receives as the function value the value of the calculation result corresponding to the position specified by the instruction received by the instruction receiving unit.

5. The electronic nomogram according to claim 1, wherein the nomogram image data is partitioned into a plurality of regions in response to the value of the calculation result of the predetermined function; and
wherein the electronic nomogram further comprises:
a boundary value receiving unit for receiving a boundary value serving as a value corresponding to a boundary of the regions; and
a boundary modifying unit for modifying the nomogram image data such that a graph in accordance with which the predetermined function provides the boundary value received by the boundary value receiving unit is the boundary of the regions.

6. The electronic nomogram according to claim 5, wherein the instruction receiving unit receives an instruction specifying a position through which the graph of the predetermined function corresponding to the boundary of the regions displayed on the nomogram runs;
wherein the numerical value acquiring unit acquires the first and second axis values corresponding to the position specified by the instruction received by the instruction receiving unit;
wherein the calculation unit calculates the predetermined function that uses as the arguments the first and second numerical values, corresponding to the position specified by the instruction received by the instruction receiving unit, and acquired by the numerical value acquiring unit to obtain the value of the calculation result of the predetermined function; and
wherein the function value receiving unit receives as the function value the value of the calculation result corresponding to the position specified by the instruction received by the instruction receiving unit.

7. The electronic nomogram according to claim 1, wherein the nomogram image data is partitioned into a plurality of regions in response to the value of the calculation result of the predetermined function;
wherein at least one of the regions serves as a target region,
wherein the electronic nomogram further comprises a difference information generation unit for generating, as difference information, information related to a difference between the first axis values of the position of the point graphic and the target region and/or a difference between the second axis values of the position of the point graphic and the target region,
wherein the image generation unit generates, as difference information image data, image data of the difference information generated by the difference information generation unit, and
wherein the image display unit also displays the difference information image data.

8. The electronic nomogram according to claim 1, wherein the instructing receiving unit receives the instruction specifying positions of a plurality of point graphics;
wherein the image generation unit generates image data of the plurality of point graphics; and
wherein the image display unit displays the image data of the plurality of point graphics.

9. The electronic nomogram according to claim 8, wherein the plurality of point graphics respectively correspond to different targets defined by the first and second axis values.

10. The electronic nomogram according to claim 8, wherein the plurality of point graphics respectively correspond to a history of the same target defined by the first and second axis values.

11. An electronic nomogram comprising:
an image data storing unit for storing, as nomogram image data, image data of a nomogram with a coordinate plane having a first axis and a second axis;
an instruction receiving unit for receiving an instruction specifying a position of a point graphic displayed on the nomogram and used to indicate a position on the nomogram;
a numerical value acquiring unit for acquiring first and second numerical values, the first and second numerical values being respectively first and second axis values corresponding to the position of the point graphic on the nomogram;
a calculation unit for calculating a value of a calculation result of a predetermined function that uses as arguments the first and second numerical values acquired by the numerical value acquiring unit;
an output unit for outputting the value of the calculation result of the function calculated by the calculation unit;
an image generation unit for generating, as point graphic image data, image data of the point graphic, at a position specified by the instruction received by the instruction receiving unit; and
an image display unit for displaying the nomogram image data read from the image data storing unit, and the point graphic image data generated by the image generation unit.

12. The electronic nomogram according to claim 11, wherein the output unit outputs the first and second numerical values acquired by the numerical value acquiring unit.

13. An electronic nomogram display method performed using an image data storing unit storing, as nomogram image data, image data of a nomogram with a coordinate plane having a first axis and a second axis, an instruction receiving unit, a numerical value acquiring unit, a calculation unit, an image generation unit, and an image display unit, the electronic monogram display method comprising:
an instruction receiving step of the instruction receiving unit for receiving an instruction specifying a position of a point graphic displayed on the nomogram and used to indicate a position on the nomogram;
a numerical value acquiring step of the numerical value acquiring unit for acquiring first and second numerical values, the first and second numerical values being respectively first and second axis values corresponding to the position of the point graphic on the nomogram;
a calculation step of the calculation unit for calculating a value of a calculation result of a predetermined function that uses as arguments the first and second numerical values acquired in the numerical value acquiring step;
an image generation step of the image generation unit for generating, as point graphic image data, image data of the point graphic, at a position specified by the instruction received in the instruction receiving step and generating, as calculation result image data, image data of the value of the calculation result calculated in the calculation step; and
an image display step of the image display unit for displaying the nomogram image data read from the image data storing unit, and the point graphic image data and the calculation result image data, generated in the image generation step.
